(19) United States
(12) Patent Application Publication
(10) Pub. No.: US 2026/0019235 A1
(43) Pub. Date: Jan. 15, 2026

(54) SYSTEMS AND METHODS FOR PSEUDORANDOM BATCH CODE PRINTING AND PRODUCT AUTHENTICATION VIA A TWO-DIMENSIONAL (2D) CODE USING A DOT CODE

(71) Applicant: THE PROCTER & GAMBLE COMPANY, Cincinnati, OH (US)

(72) Inventor: Jonathan Richard STONEHOUSE, Windlesham (GB)

(21) Appl. No.: 19/256,861

(22) Filed: Jul. 1, 2025

Related U.S. Application Data
(60) Provisional application No. 63/670,182, filed on Jul. 12, 2024.

(51) Int. Cl. H04L 9/06; G06K 7/14; G06K 19/06

(52) U.S. Cl. CPC H04L 9/0656; G06K 7/1417; G06K 19/06037

(57) ABSTRACT

Systems and methods are disclosed for authenticating products using two-dimensional (2D) codes and dot codes that involves generating an authenticating sequence of pseudorandom numbers via a cryptographic algorithm. The initial seed value corresponds to a specific product within a batch, with each subsequent number generated directly or indirectly from the previous one. A 2D code printing application generates two dot codes based on different sets of pseudorandom numbers in the sequence and prints them onto corresponding products within the batch. The first dot code is printed onto the first product's 2D code, while the second dot code is printed onto the second product's 2D code, allowing each product to have a unique combination of codes that can be verified to confirm its authenticity. The systems and methods use one or more processors and a printer to execute these steps, allowing for efficient and secure authentication of products within a batch.

### CROSS REFERENCE TO RELATED APPLICATIONS

This application claims the benefit, under 35 U.S.C. § 119 (c), to U.S. Provisional Application No. 63/670,182, filed Jul. 12, 2024, the entire disclosure of which is fully incorporated by reference herein.

### FIELD

The present disclosure generally relates to systems and methods for pseudorandom batch code printing and product authentication, and more particularly to, systems and methods for pseudorandom batch code printing and product authentication via a two-dimensional (2D) code using a dot code.

### BACKGROUND

Counterfeit items are a large problem in many industries, particularly in developing countries. They can erode consumer confidence or in extreme cases, cause actual, physical harm, and/or generate losses for manufacturers and distributors. Counterfeiting represents, globally, over tens of millions in losses and damages to the brand reputation of manufacturers and distributors. For example, a customer who receives a poor-quality counterfeit may associate that bad experience with the brand. Even in developed markets, where counterfeiting is a rarer occurrence, significant brand risk exists. For example, a study from the 1990s on a poor-quality counterfeit shampoo released in Europe showed that on average a disappointed consumer told six people about a poorly performing product.

A variety of methods have been used over the years to allow the verification of the authenticity of items, including holographic labels, RFID tags, and overt and covert codes. Although these methods may provide a way to detect counterfeit items, they also involve additional costs and/or complexity to the production or otherwise manufacturing process. Cost constraints are particularly acute for fast-moving consumer goods that have low margins. For example, product tracking techniques such as those that rely on blockchain require consistent physical control of supply chains, which is not possible in many practical scenarios wherein a manufacturer or distributor lacks such control. Still further, existing counterfeit detection techniques do not utilize existing distributed mobile computing resources, e.g., via crowdsourcing.

A variety of techniques have recently been proposed that involve manipulation of existing codes and/or information provided on a product for tracking purposes. For example, WO 2012/109294 A1 discloses a method of printing a product code with one or more modified characters. The method uses an existing alphanumeric value that is determined by, for example, the date and location of manufacture, and existing printing technology. An algorithm is applied to digits in the original code (pre-modification), and based on the output of the algorithm, one or more digits in the code are selected and modified in a predetermined manner. For example, the modification may involve removal of a pixel of an individual digit that is barely perceptible to the naked eye, but that provides a clear signal to someone actively seeking to verify the authenticity of the product.

While such techniques are considerably useful in terms of helping manufacturers, retailers, and end users to ascertain the authenticity of products, counterfeiters are becoming more sophisticated at interpreting such codes and being able to replicate them. This problem becomes exacerbated for manufacturers or otherwise entities using imaging analysis to detect counterfeit items or products. This is because the ever-increasing numbers of counterfeit items, each of which may have various shapes, sizes, and graphics—and, each of which may employ various techniques to mimic authentic products—can be vastly different in their configuration and/or appearance, even if such differences may be subtle in visual appearance. Such vast numbers of different counterfeit products and images create difficulties in building robust image-based systems to combat product counterfeiting, at least because it is difficult for a manufacturer or entity to readily identify, gather, or otherwise access the various numbers and different types of counterfeit images of counterfeit products as created by different counterfeiters for building and developing robust and/or accurate systems.

For example, US 2019/0392458 A1, entitled “Method of Determining Authenticity of a Consumer Good,” describes a method of classifying a consumer good as authentic, where the method leverages machine learning and the use of steganographic features on a given authentic consumer good. While the method may be used to identify steganographic features on authentic consumer good(s) for the purpose of authentication consumer goods, the method, and its underlying machine learning model, is limited because it relies on vast numbers of real-world images of non-authentic consumer goods, which can be prohibitively costly or time consuming to obtain, organize, structure, or otherwise aggregate. For the same reasons, data pre-processing and/or training of a robust machine-learning model with such real-world images of non-authentic consumer goods can cause errors and delays, or other issues in preparing or supervising the training dataset that would otherwise be required for generation of a robust machine learning model. This can come about because such vast numbers of real-world images of non-authentic consumer goods may have different, unknown, and/or underrepresented depictions of non-authentic features, which would cause significant manual processing and/or manipulation to prepare a training dataset for generation of a robust machine learning model.

Still further, an underlying issue of each of these, and other more conventional solutions for combatting counterfeits, involves printing unique per item codes on each and storing the large quantity of these codes, and/or other data to before authentication and/or counterfeit detection. In particular, the authentic codes are typically stored in a database and must be looked-up each time an authentication check (or match) is made to determine whether a particular product is authentic or counterfeit. For manufacturers that produce millions or billions of products, the storage and maintenance of such codes is technically inefficient typically requiring immense computer memory storage capacity, such large capacity databases, where access and utilization of these data resources is needed in order to scale with a large amount of products.

For the foregoing reasons, there is a need for systems and methods for pseudorandom batch code printing and product authentication via a two-dimensional (2D) code using a dot code.

### SUMMARY

Counterfeit products constitute a global problem. The manufacturing and producing industry has a need for more advanced resources and distributed involvement to identify counterfeits. This is because mass serialization of consumer goods results in billions of possible items, which creates an opportunity for counterfeiters to create counterfeit products and insert them into market channels. Authentication of such products can be accomplished by comparing an unknown code to a database of valid codes. However, creating, printing, and databasing a large volume of products is untenable, or at least inefficient.

By contrast, pseudo random code technology provides a solution to achieve the same objective by using alphanumeric digits. For example, a pseudo random code can be generated by using a seed value that is fed into an algorithm in the batch code printer to generate a set of different alphanumeric digit codes. An example of a seed value is the Julian date (or production date, found in a classic batch code). As the date changes every day, so can the set of pseudo random codes that are available for the day. In practice this means that in each printing event, a unique pseudo random code is printed along with a classic batch code (using the same printer and at the same time). In such implementations, checking for a valid code can be implemented by entering the seed value that is visible (e.g., a Julian date) on a product into an algorithm configured to generate the set of valid pseudo random codes for the batch. The algorithm can determine whether the pseudo random code on the product matches one within a set of valid codes. Such approach allows millions of possible combinations of pseudo random code to be generated each day, but where only a defined set of codes (as defined by the algorithm) are valid. In such implementations, counterfeiters are forced to: (i) not print the code, where an absent code indicates a counterfeit product; (ii) guess what a valid code is for the day, which is statistically very difficult; or (iii) copy a valid code over-and-over again, which indicates a counterfeit product since the code is for only a one-time printing event. Such pseudo random code technology is protected by a filed patent application, owned by The Procter & Gamble Company (P&G), i.e., U.S. Pat. Publ. No. 2024/0005339 A1 (filed Jun. 29, 2022), entitled “METHODS AND SYSTEMS FOR PSEUDORANDOM BATCH CODE PRINTING AND PRODUCT AUTHENTICATION.”

The disclosed systems and methods herein improve and differ from the aforementioned pseudo random code technology by solving a long-standing problem of performing counterfeit detection at scale, without incurring significant capital and time expenditures, by leveraging product authentication via two-dimensional (2D) codes using dot codes as described herein. Such new approach takes advantage of 2D code (e.g., QR code) product printing transitions, where product printing techniques transition from one dimensional (1D) to 2D codes for product identification. Such printing can also be implemented efficiently, because it can be performed by controlling a printer (e.g., an online printer) to generate and/or print the dot codes, thereby creating a series dot codes based on pseudorandom numbers, e.g., one for each product in a given product batch.

For example, the systems and methods described herein generate dot codes for printing on otherwise superimposing on 2D codes (e.g., QR codes) on products. Imaging technology (e.g., digital images taken by computing devise such as a camera) can then be used to image the 2D codes, having the respective dot codes, where the dot codes can be used to determine whether a given product is authentic or counterfeit.

Dot codes may be printed on or otherwise superimposed on 2D codes (e.g., QR codes) because scannable 2D codes, such a QR codes, build redundancy (e.g., have redundant patterns) so that a proportion of 2D code can be damaged and/or used (e.g., borrowed) for other purposes, and where the underlying information in the 2D code (e.g., QR code) can still be read or detected by a machine reader, such as a scanner and/or imaging device, e.g., a computing device with a camera. Due to the in-built error correction in 2D codes (e.g., QR codes), the systems and methods described herein borrow, or otherwise print over or superimpose, a dot code on a number of pixels in the 2D code (e.g., QR code) to provide an authentication and/or counterfeit detection layer for a given product, which may be a product in a product batch. In this way, the systems and methods described herein implement pseudorandom batch code printing and product authentication via a two-dimensional (2D) code using a dot code.

In some aspects, the techniques described herein relate to a system configured for product authentication via two-dimensional (2D) codes using dot codes, the system including: one or more processors; and a 2D code printing application (app) including computing instructions configured to be executed by the one or more processors, wherein the computing instructions of the 2D code printing app, when executed by the one or more processors, are configured to cause the one or more processors to: generate an authenticating sequence of authentic pseudorandom numbers by inputting an initial seed value into a cryptographic algorithm to output an initial authenticating pseudorandom number in the authenticating sequence, wherein the initial seed value corresponds to a first product that is part of a product batch, wherein the first product has a first 2D code printed thereon, wherein a second product has a second 2D code printed thereon, the second product being part of the product batch, wherein each subsequent authenticating pseudorandom number in the authenticating sequence is generated directly or indirectly from the initial authenticating pseudorandom number whereby the initial authenticating pseudorandom number or a subsequent derivative thereof is input into the cryptographic algorithm to output a next authenticating pseudorandom number of the authenticating sequence, generate a first dot code based on a first set of one or more pseudorandom numbers in the authenticating sequence, generate a second dot code based on a second set of one or more pseudorandom numbers in the authenticating sequence, control, by the one or more processors, a printer to print the first dot code on the first 2D code of the first product, and control, by the one or more processors, the printer to print the second dot code on the second 2D code of the second product.

In some aspects, the techniques described herein relate to a method for product authentication via two-dimensional (2D) codes using dot codes, the method including: generating, by a 2D code printing application (app) including computing instructions configured to be executed by one or more processors, an authenticating sequence of authentic pseudorandom numbers by inputting an initial seed value into a cryptographic algorithm to output an initial authenticating pseudorandom number in the authenticating sequence, wherein the initial seed value corresponds to a first product that is part of a product batch, wherein the first product has a first 2D code printed thereon, wherein a second product has a second 2D code printed thereon, the second product being part of the product batch, wherein each subsequent authenticating pseudorandom number in the authenticating sequence is generated directly or indirectly from the initial authenticating pseudorandom number whereby the initial authenticating pseudorandom number or a subsequent derivative thereof is input into the cryptographic algorithm to output a next authenticating pseudorandom number of the authenticating sequence, generating, by the 2D code printing app, a first dot code based on a first set of one or more pseudorandom numbers in the authenticating sequence, generating, by the 2D code printing app, a second dot code based on a second set of one or more pseudorandom numbers in the authenticating sequence, controlling, by the one or more processors, a printer to print the first dot code on the first 2D code of the first product, and controlling, by the one or more processors, the printer to print the second dot code on the second 2D code of the second product.

In some aspects, the techniques described herein relate to a tangible, non-transitory computer-readable medium storing instructions for product authentication via two-dimensional (2D) codes using dot codes, that when executed by one or more processors cause the one or more to: generate, by a 2D code printing application (app) including computing instructions configured to be executed by one or more processors, an authenticating sequence of authentic pseudorandom numbers by inputting an initial seed value into a cryptographic algorithm to output an initial authenticating pseudorandom number in the authenticating sequence, wherein the initial seed value corresponds to a first product that is part of a product batch, wherein the first product has a first 2D code printed thereon, wherein a second product has a second 2D code printed thereon, the second product being part of the product batch, wherein each subsequent authenticating pseudorandom number in the authenticating sequence is generated directly or indirectly from the initial authenticating pseudorandom number whereby the initial authenticating pseudorandom number or a subsequent derivative thereof is input into the cryptographic algorithm to output a next authenticating pseudorandom number of the authenticating sequence, generate, by the 2D code printing app, a first dot code based on a first set of one or more pseudorandom numbers in the authenticating sequence, generate, by the 2D code printing app, a second dot code based on a second set of one or more pseudorandom numbers in the authenticating sequence, control, by the one or more processors, a printer to print the first dot code on the first 2D code of the first product, and control, by the one or more processors, the printer to print the second dot code on the second 2D code of the second product.

In accordance with the above, and with the disclosure herein, the present disclosure includes improvements in computer functionality or in improvements to other technologies at least because the disclosure describes that, e.g., a server, or otherwise computing device (e.g., a user computer device), is improved where the ability of the server or computing device is enhanced by a cryptographic algorithm configured to generate authenticating and test sequence of authentic pseudorandom numbers from which corresponding pseudorandom number(s) and/or dot code(s) can be derived. The pseudorandom number(s) and/or dot code(s) can be printed, by a printer, onto corresponding products. The server or computing device does not need to store the pseudorandom number(s) and/or dot code(s), or even the related batch codes, into computer memory or a database for purposes of later performing product authentication as a conventional system would require. Instead, the cryptographic algorithm is stored, where the cryptographic algorithm is a lightweight formula that involves little memory storage. A later request to authenticate a product can then reuse the cryptographic algorithm by inputting the information printed on the product, and without having to access computer memory and/or a database. Thus, the systems and methods described herein provide the ability to serialise a product without needing a significant information technology (IT) infrastructure of databasing or otherwise storing the set of valid codes and granting access to this database for authentication purposes. Overall, this solution results in reduced computer memory requirements, where a server or otherwise computing device does not need to store related batch codes, which is an improvement over prior art systems and methods, especially when batch codes are generated at scale for hundreds of thousands, millions, or even billions of products.

It will be appreciated by those of skill in the art that the cryptographic algorithm, and/or parameters thereof, is a low memory resource used for generating the authenticating sequence of pseudorandom numbers and related pseudorandom numbers generated for or determined from dot codes printed on products. Thus, the cryptographic algorithm, and/or parameters thereof may be transmitted over a computer network and used by the manufacturer/distributor and/or a third party to determine the authenticity of products. That is, in some aspects, the manufacturer/distributor may make the cryptographic algorithm available to third parties (e.g., a retailer) for the third parties' use in determining the authenticity of products. This provides an improvement to conventional systems that instead require access to and/or transfer to a large set of authenticating batch codes stored in conventional databases.

In addition, the present disclosure includes applying certain of the claim elements with, or by use of, a particular machine, e.g., a printer, including continuous ink jet, thermal ink jet, drop on demand, thermal transfer printers, or laser ablation or other laser marking devices, hot-melt wax printers, for printing anti-counterfeit codes or otherwise features on one or more products or substrates thereof, where such printed codes or otherwise features may then be captured in digital images or scans to detect whether the product is authentic or counterfeit based on the information in the image or from the scan, e.g., the information comprising an pseudorandom number and/or dot code printed on the product.

Still further, the compact form of the batch codes of the present invention, with its pseudorandom number and/or dot code, allows for a printer to print on smaller surface areas of physical products. That is, minimal space is needed on the product to print dot codes, and printing can be performed using a same printer that prints batch codes. The space needed for a given dot code could be the equivalent space taken by 1 or 2 digits. This results in improvements to physical product designs, shapes, and/or configurations, as the compact batch codes takes less space or material on a substrate of given product and its shape.

Still further, an improvement to the underlying printer is achieved with respect to the operation of existing printers because the batch codes of the present invention, with its pseudorandom number and/or dot code, is more compact, thereby reducing the time, and in some cases ink or other substrate material or alternation, needed to physically print the batch code on a product in real-time. This not only allows the printer to print batch codes at a faster line-speed, but also reduces the time a printer needs to print a given number of batch codes. Fewer printers can be used to print a same number of batch codes on given products.

In addition, the present disclosure includes specific features other than what is well-understood, routine, conventional activity in the field, or adds unconventional steps that confine the claim to a particular useful application, e.g., systems and methods for pseudorandom batch code printing and product authentication via a two-dimensional (2D) code using a dot code as described herein.

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an aspect of a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present aspects are not limited to the precise arrangements and instrumentalities shown, wherein:

FIG. 1A illustrates an example system configured for product authentication via two-dimensional (2D) codes using dot codes, in accordance with various aspects disclosed herein.

FIG. 1B illustrates an example method configured for product authentication via 2D codes using dot codes, including printing dot codes onto products of a product batch, in accordance with various aspects disclosed herein.

FIG. 1C further illustrates a method for authenticating products based on dot codes printed thereon as described for the method of FIG. 1B, in accordance with various aspects disclosed herein.

FIG. 2A illustrates an example information for an initial seed value in accordance with various aspects disclosed herein.

FIG. 2B illustrates a further example of information for an initial seed value, in accordance with various aspects disclosed herein.

FIG. 3 illustrates an example cryptographic algorithm used to generate a sequence of pseudorandom alphanumeric numbers, in accordance with various aspects disclosed herein.

FIG. 4A illustrates an example dot code printing algorithm in accordance with various aspects disclosed herein.

FIG. 4B illustrates an example reverse dot code printing algorithm in accordance with various aspects disclosed herein.

FIG. 4C illustrates an example arbitrary dot code printing algorithm in accordance with various aspects disclosed herein.

FIG. 4D illustrates an example border dot code printing algorithm in accordance with various aspects disclosed herein.

FIG. 4E illustrates an example pattern dot code printing algorithm in accordance with various aspects disclosed herein.

FIG. 5A illustrates an example 2D code, in accordance with various aspects disclosed herein.

FIG. 5B illustrates an example dot code as printed on the 2D code of FIG. 5A, in accordance with various aspects disclosed herein.

FIG. 5C illustrates a further example dot code as printed on the 2D code of FIG. 5A, in accordance with various aspects disclosed herein.

FIG. 6 illustrates example 2D codes each defining a percentage of pixels than can be missing in accordance with various aspects disclosed herein.

The Figures depict preferred aspects for purposes of illustration only. Alternative aspects of the systems and methods illustrated herein may be employed without departing from the principles of the invention described herein.

### DETAILED DESCRIPTION OF THE INVENTION

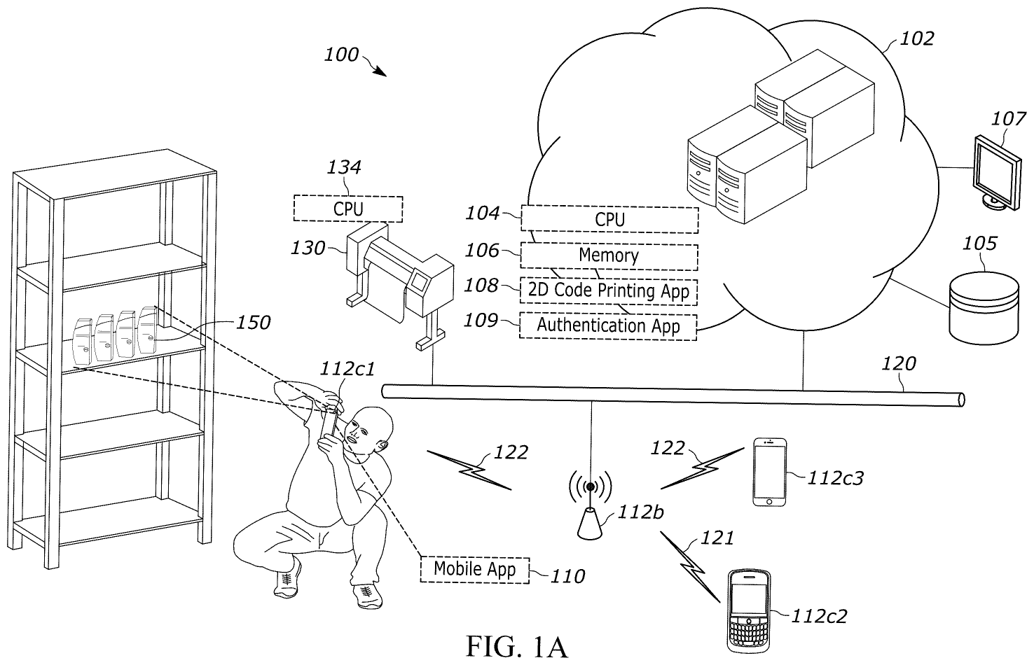

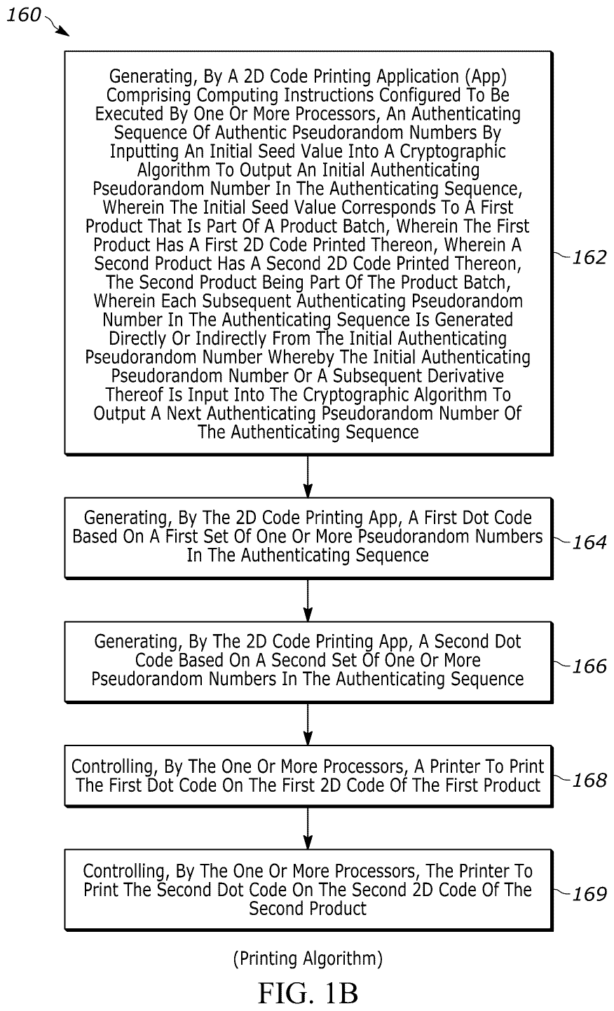

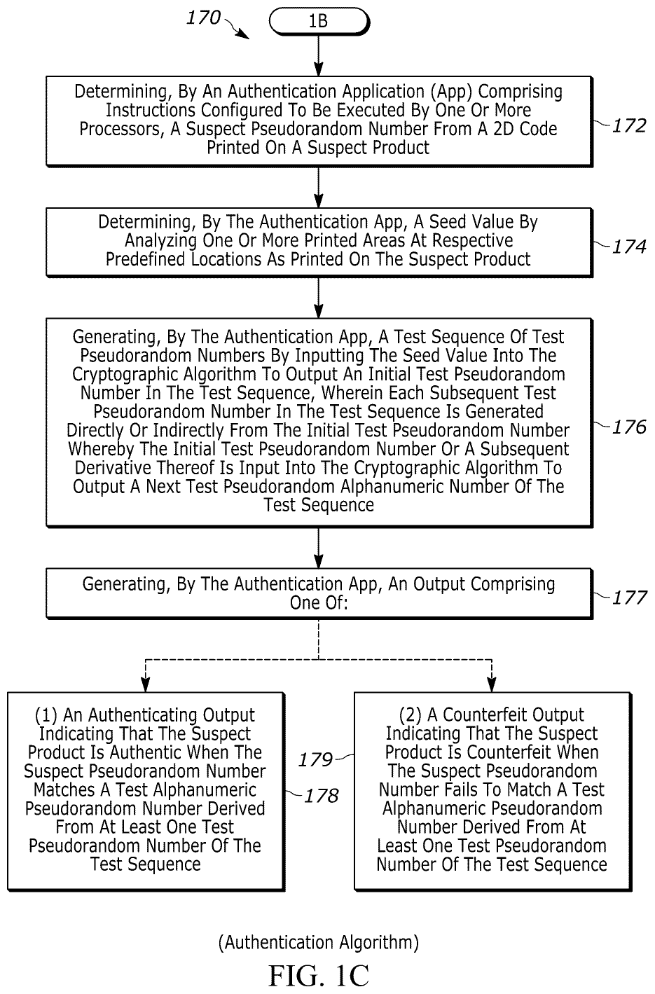

FIG. 1A illustrates an example system 100 configured for product authentication via two-dimensional (2D) codes using dot codes, in accordance with various aspects disclosed herein. In the example aspect of FIG. 1A, the system 100 includes server(s) 102, which may comprise one or more computer servers. In various aspects, server(s) 102 comprise multiple servers, which may comprise multiple, redundant, or replicated servers as part of a server farm. In still further aspects, server(s) 102 may be implemented as cloud-based servers, such as a cloud-based computing platform. For example, server(s) 102 may be any one or more cloud-based platform(s) such as MICROSOFT AZURE, AMAZON AWS, or the like. Server(s) 102 may include one or more processor(s) 104 as well as one or more computer memory 106.

Memory 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memory 106 may store an operating system (OS) (e.g., Microsoft Windows, Linux, UNIX, etc.) capable of facilitating the functionalities, apps, methods, or other software as discussed herein. Memory 106 may also store a 2D code printing application (app) 108 and/or authentication app 109, which may each comprise computing instructions for pseudorandom number based printing and product authentication, respectively, as described herein. As described herein, 2D code printing app 108 and/or authentication app 109 are accessible, across a computer network (e.g., computer network 120), by a user computing device (e.g., user computing device 112c1), for example through communication via mobile app 110 and/or via an application programming interface (API) such as a representational state transfer (RESTful) API.

In addition, memory 106 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, 2D code printing app 108 and/or an authentication app 109, where each may be configured to facilitate their various functionalities discussed herein.

Additionally, or alternatively, 2D code printing app 108 and/or authentication app 109 may be stored in database 105, which is accessible or otherwise communicatively coupled to server(s) 102. It should be appreciated that one or more other applications are envisioned, that may be in addition to the 2D code printing app 108 and/or an authentication app 109, and that may be executed by the processor(s) 104. For example, the one or more APIs may provide, for example, third party access to a counterfeit product list stored in the database 105. For example, the counterfeit product list may comprise a list of known counterfeit codes that counterfeiters have previously used on counterfeit products.

The processor(s) 104 may be connected to the memory 106 via a computer bus (not depicted) responsible for transmitting electronic data, data packets, or otherwise electronic signals to and from the processor(s) 104 and memory 106 in order to implement or perform the machine readable instructions, methods, processes, elements or limitations, as illustrated, depicted, or described for the various flowcharts, illustrations, diagrams, figures, and/or other disclosure herein.

Processor(s) 104 may interface with memory 106 via the computer bus to execute an operating system (OS). Processor(s) 104 may also interface with the memory 106 via the computer bus to create, read, update, delete, or otherwise access or interact with the data stored in memory 106 and/or the database 105 (e.g., a relational database, such as Oracle, DB2, MySQL, or a NoSQL based database, such as MongoDB). The data stored in memory 106 and/or database 105 may include all or part of any of the data or information described herein, including, for example, font set table(s), codes, images, or other images and/or information, artwork, product labels, graphics, logos, or the like, or as otherwise described herein, in addition to the counterfeit product list.

Server(s) 102 may further include a communication component configured to communicate (e.g., send and receive) data via one or more external/network port(s) to one or more networks or local terminals, such as computer network 120 and/or a terminal 107 (for rendering or visualizing) described herein. In some aspects, server(s) 102 may include a client-server platform technology such as ASP.NET, Java J2EE, Ruby on Rails, Node.js, a web service or online API, responsive for receiving and responding to electronic requests. The server(s) 102 may implement the client-server platform technology that may interact, via the computer bus, with the memory(s) 106 (including the applications(s), component(s), API(s), data, etc. stored therein) and/or database 105 to implement or perform the machine readable instructions, methods, processes, elements or limitations, as illustrated, depicted, or described for the various flowcharts, illustrations, diagrams, figures, and/or other disclosure herein.

In various aspects, the server(s) 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120. In some aspects, computer network 120 may comprise a private network or local area network (LAN). Additionally, or alternatively, computer network 120 may comprise a public network such as the Internet.

Server(s) 102 may further include or implement an operator interface configured to present information to an administrator or operator and/or receive inputs from the administrator or operator. An operator interface may provide a display screen (e.g., via the terminal 107). Server(s) 102 may also provide I/O components (e.g., ports, capacitive or resistive touch sensitive input panels, keys, buttons, lights, LEDs), which may be directly accessible via, or attached to, server(s) 102 or may be indirectly accessible via or attached to the terminal 107. According to some aspects, an administrator or operator may access the server 102 via the terminal 107 to review information, make changes, input training data or images, execute 2D code printing app 108, execute authentication app 109, and/or perform other functions.

As described herein, in some aspects, server(s) 102 may perform the functionalities as discussed herein as part of a “cloud” network or may otherwise communicate with other hardware or software components within the cloud to send, retrieve, or otherwise analyse data or information described herein.

In general, a computer program or computer based product, application (app) (e.g., 2D code printing app 108 and/or authentication app 109), or code, or other computing instructions described herein may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 104 (e.g., working in connection with the respective operating system in memory 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

As shown in FIG. 1, server(s) 102 are communicatively connected, via computer network 120 to the one or more user computing devices 112 via base station 112b. In some aspects, base station 112b may comprise a cellular base station, such as cell tower(s), communicating to the one or more user computing devices 112c1-112c3 via wireless communications 121 based on any one or more of various mobile phone standards, including NMT, GSM, CDMA, UMMTS, LTE, 5G, or the like. Additionally or alternatively, a base station 112b may comprise one or more comprise routers, wireless switches, or other such wireless connection points communicating to the one or more user computing devices 112c1-112c3 via wireless communications 122 based on any one or more of various wireless standards, including by non-limiting example, IEEE 802.11a/b/c/g (WIFI), the BLUETOOTH standard, or the like.

Any of the one or more user computing devices 112c1-112c3 may comprise mobile devices and/or client devices for accessing and/or communicating with server(s) 102. Such mobile devices may comprise one or more mobile processor(s) and/or a digital camera for capturing images, such as images as described herein (e.g., images of product and/or codes, dot codes, batch codes, pseudorandom numbers, or other information as described herein). In various aspects, user computing devices 112c1-112c3 may comprise a mobile phone (e.g., a cellular phone), a tablet device, a personal data assistance (PDA), a wearable device, or the like, including, by non-limiting example, an APPLE iPhone or iPad device or a GOOGLE ANDROID based mobile phone or tablet.

In additional aspects, user computing devices 112c1-112c3 may comprise a retail computing device. A retail computing device may comprise a user computer device configured in a same or similar manner as a mobile device, e.g., as described herein for user computing devices 112c1-112c3, including having a processor and memory, for implementing, or communicating with (e.g., via server(s) 102), as described herein. Additionally, or alternatively, a retail computing device may be located, installed, or otherwise positioned within a retail environment to allow users and/or customers of the retail environment to utilize the systems and methods for product authentication via two-dimensional (2D) codes using dot codes on site within the retail environment. For example, the retail computing device may be installed within a kiosk for access by a user. The user may then upload or transfer images or scan information (e.g., from a user mobile device) to the kiosk to implement the product authentication via two-dimensional (2D) codes using dot codes described herein. Additionally, or alternatively, the kiosk may be configured with a camera or scanner to allow the user to take new images or scans to detect counterfeit product(s) and/or for upload and transfer to server(s) 102. In such aspects, the user would be able to use the retail computing device to receive and/or have rendered an indication of whether the product is authentic or counterfeit, as described herein, on a display screen of the retail computing device.

In various aspects, the one or more user computing devices 112c1-112c3 may implement or execute an operating system (OS) or mobile platform such as APPLE's iOS and/or GOOGLE'S ANDROID operation system. Any of the one or more user computing devices 112c1-112c3 may comprise one or more processors and/or one or more memory for storing, implementing, or executing computing instructions or code, which may comprise or be a part of a mobile application (app) (e.g., mobile app 110), as described in various aspects herein. For example, mobile app 110 may be installed on, or be executed on, a user computing device (e.g., user computing device 112c2). Mobile app 110 may be a downloadable app, e.g., from server(s) 102 or an app store, such as the APPLE APP store or GOOGLE PLAY store. As shown in FIG. 1A, mobile app 110 as described herein may be stored locally on a memory of a user computing device (e.g., user computing device 112c1). Mobile app 110 may comprise computing instructions implemented on user computing device 112c1. In some aspects, mobile app 110 may interact with 2D code printing app 108 and/or authentication app 109. For examples, in some aspects, mobile app 110 may comprise a client-device portion implemented on a user computing device (e.g., user computing device 112c2) that communicates, across computer network 120, to send and/or receive instructions from a server-side portion (e.g., 2D code printing app 108 and/or authentication app 109) implemented on server(s) 102. In addition, any of mobile app 110, 2D code printing app 108, and/or authentication app 109 may send instructions across computer network to printer 130 for controlling printer 130. The instructions may be executed by a processor (e.g., processor 134) of the printer 130.

User computing devices 112c1-112c3 may comprise a wireless transceiver to receive and transmit wireless communications 121 and/or 122 to and from base station 112b. In various aspects, pixel based images (e.g., images depicting codes, such as batch code(s), dot code(s), and/or alphanumeric number(s), or elsewhere as described herein) or scan data comprising dot code information may be transmitted via computer network 120 to server(s) 102 for analysis as described herein.

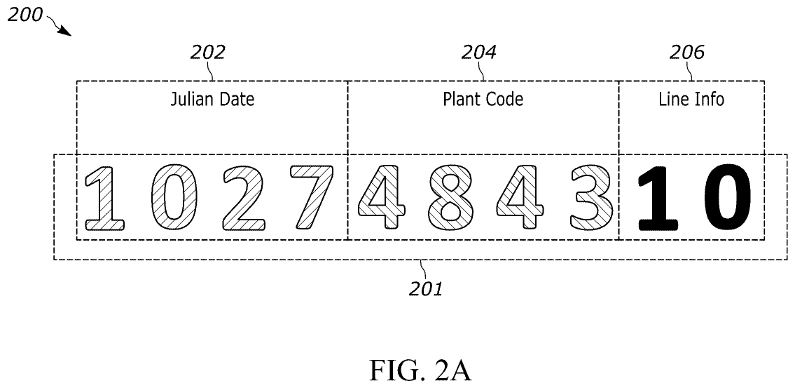

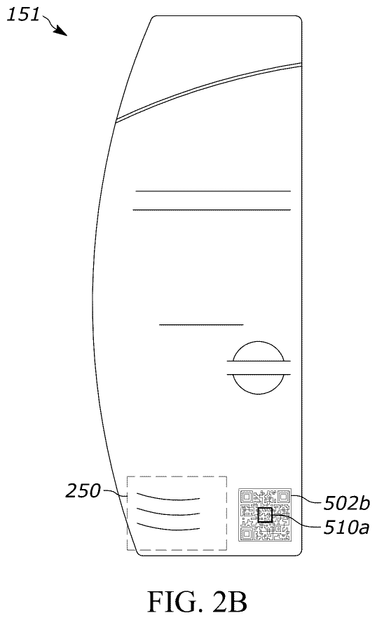

In addition, the one or more user computing devices 112c1-112c3 may include a digital camera and/or digital video camera for capturing or taking digital images and/or frames (e.g., which can be any one or more of images, such as image of information as shown for FIGS. 2A and 2B). Each digital image may comprise pixel data that may be analysed, e.g., to determine whether a product is authentic and/or inauthentic as described herein. For example, a digital camera and/or digital video camera of, e.g., any of user computing devices 112c1-112c3, may be configured to take, capture, or otherwise generate digital images of products and, at least in some aspects, may store such images in a memory of a respective user computing devices. Additionally, or alternatively, user computing devices 112c1-112c3 may also include a scanner for scanning alphanumeric numbers and/or dot codes as described herein. Such digital images and/or scan data can be transmitted to and/or stored on memory 106 and/or database 105 of server(s) 102, e.g., for analysis as described herein.

Still further, each of the one or more user computer devices 112c1-112c3 may include a display screen for displaying graphics, images, text, product authentication or counterfeit information, data, pixels, features, and/or other such visualizations or information as described herein. In various aspects, graphics, images, text, product authentication or counterfeit information, data, pixels, features, and/or other such visualizations or information may be received from server(s) 102 for display on the display screen of any one or more of user computer devices 112c1-112c3. Additionally, or alternatively, a user computer device may comprise, implement, have access to, render, or otherwise display, at least in part, an interface or a graphic user interface (GUI) for displaying text and/or images on its display screen.

The user may use the computing device 112c1, for example, to capture one or more images of a product. As shown for FIG. 1A, the image may be an image of a product of a product batch (e.g., product batch 150). An image corresponding to a product of the product batch 150 may be any suitable product of the manufacturer/distributor, such as a baby care product, a fabric care product, a family care product, a feminine care product, a grooming product, a hair care product, a home care product, an oral care product, a personal health care product, a skin and personal care product, a clear product, and/or other similar consumer product(s).

In some aspects, computing instructions and/or applications executing at the server (e.g., server(s) 102) and/or at a mobile device (e.g., mobile device 112c1) may be communicatively connected for analysing pixel data of an image and/or scan data (e.g., as shown for either of FIGS. 2A and 2B) for detecting whether a corresponding product is authentic or counterfeit, as described herein. For example, one or more processors (e.g., processor(s) 104) of server(s) 102 may be communicatively coupled to a mobile device via a computer network (e.g., computer network 120). In such aspects, 2D code printing app 108 and/or authentication app 109 may comprise a server app portion configured to execute on the one or more processors of the server (e.g., server(s) 102). Similarly, mobile app 110 may comprise a mobile app portion configured to execute on one or more processors of the mobile device (e.g., any of one or more user computing devices 112c1-112c3). In such aspects, the server app portion is configured to communicate with the mobile app portion. The server app portion or the mobile app portion may each be configured to implement, or partially implement, one or more of: (1) generating an authenticating sequence of authentic pseudorandom numbers by inputting an initial seed value (201) into a cryptographic algorithm to output an initial authenticating pseudorandom number in the authenticating sequence; (2) generating a first dot code based on a first set of one or more pseudorandom numbers in the authenticating sequence; (3) generating a second dot code based on a second set of one or more pseudorandom numbers in the authenticating sequence; (4) controlling a printer to print the first dot code on the first 2D code of the first product, and (5) controlling the printer to print the second dot code on the second 2D code of the second product, as described herein.

FIG. 1A further comprises printer 130. In various aspects, printer 130 is connected via network 120 to server(s) 102 and may receive print submissions, commands, or computing instructions, and can execute such print submissions, commands, or computing instructions by a processor (e.g., by processor 134), to print product code(s), steganographic features, dot codes, batch codes, or other features, values, or information on products and/or substrates of products. For example, printer 130 may comprise an online printer and may be configured for printing in various mediums or in different ways (e.g., continuous inkjet, laser, thermal transfer, embossed, etc.). In some aspects, printer 130 is a printer under the direction or control of the owner or operator of server(s) 102, and/or a user computing device (e.g., user computing device 112c1) where printer 130 is part of a same network. In other aspects, printer may be a printer under the direction or control of a third-party and may be connected to server(s) 102 via the Internet. Herein, a batch code generally comprises a code having information and/or graphical elements (e.g., a timestamp, plant code, line number, pseudorandom number, dot code, or as otherwise described herein). It is to be understood that a dot code can include, link, or otherwise reference or represent batch code information too, including the example batch code information provided herein.

Printer 130 is controlled (e.g., by processor 134) to print a dot code, or otherwise product code, on a product or otherwise substrate of product. Printer 130 may comprise a continuous ink jet printer, a thermal ink jet printer, a drop on demand printer, a thermal transfer printer, hot-melt wax printer, and/or a laser ablation printer or other laser marking device. In a preferred aspect, a printer may be configured to enable determination and/or printing of the alphanumeric digits, dots, dot codes, 2D codes, QR codes, or other codes or information, on a product or substrate thereof. For example, in one example, a printer manufactured by DOMINO is modified, for example configured via software for controlling the printer, to determine and print of the alphanumeric digits. A further aspect could be the use of a digital artwork printer to print a code. The substrate may be any desired substrate, including porous and non-porous materials, a primary and secondary packaging material, and/or, generally, the products themselves, typically consumer products. In some aspects, a printer (e.g., printer 130) may be controlled by the 2D code printing app 108 to generate a pseudo-random sequence of numbers and print 2D codes and/or dot codes on respective products. These numbers may then be used to select or otherwise determine the pseudorandom number and for printing on the substrate and/or product as described herein.

FIG. 1B illustrates an example method 160 configured for product authentication via two-dimensional (2D) codes using dot codes, including printing dot codes onto products of a product batch, in accordance with various aspects disclosed herein. In various aspects, a 2D code may comprise a QR code. Additionally, or alternatively, a 2D code may comprise a 2D data matrix code.

At block 162, method 160 comprises generating, by a 2D code printing application (e.g., 2D code printing app 108) implementing computing instructions configured to be executed by one or more processors (e.g., processor(s) 104), an authenticating sequence of authentic pseudorandom numbers. More generally, and by way of non-limiting example, a sequence of pseudorandom numbers may be generated by a pseudorandom number generator (PRNG), which may also be known as a deterministic random bit generator (DRBG). More generally, a PRNG comprises an algorithm for generating a sequence of numbers that are, or that approximate the properties of, a sequences of random numbers. A PRNG-generated sequence is determined by an initial value, referred to herein as an initial seed value or otherwise seed. In various aspects, 2D code printing app 108 may comprise a PRNG for generating the authenticating sequence of authentic pseudorandom numbers. The PRNG may also be used for generating the test sequence of pseudorandom numbers as further described herein. It is to be understood that different and/or additional random number generators may be used to generate a sequence of pseudorandom numbers.

The authenticating sequence of authentic pseudorandom numbers may be generated by inputting, e.g., by 2D code printing app 108, an initial seed value into a cryptographic algorithm (e.g., cryptographic algorithm 300) to output an initial authenticating pseudorandom number in the authenticating sequence. The initial seed value can correspond to a first product that is part of a product batch, where the first product has a first 2D code (e.g., a first QR code) printed thereon, for example, as shown for FIG. 2B. More generally, an initial seed value may comprise, by non-limiting, example, any one or more of initial seed value 201, initial seed value 250 (printed product surface information), initial seed value of dot code 408 from augmented 2D code 502b, and/or initial seed value of dot code 408 of grouping of dots 510a, as shown and described herein for FIGS. 2A and 2B.

Method 160 comprises a second product having a second 2D code (e.g., a second QR code) printed thereon. The second product may be part of the product batch that the first product is part of.

In some aspects, the first 2D code and the second 2D code comprise different codes, which each product has its own code (i.e., serialization). However, in other aspects, a plurality of products (e.g., the first 2D code and the second 2D code) can share or have a same 2D code with a same pseudorandom number used for a number of products in a batch. Such numbers of products may preferably include 2 to 10 products, and preferably less than 5 such products.

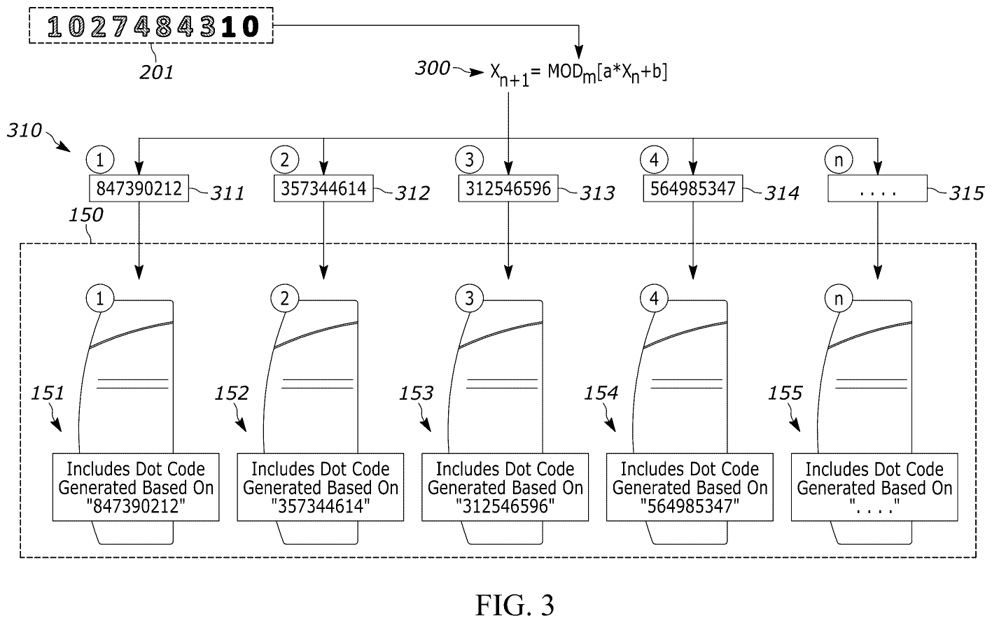

With further reference to method 160, each subsequent authenticating pseudorandom number in the authenticating sequence is generated directly or indirectly from the initial authenticating pseudorandom number (e.g., the first number output by cryptographic algorithm). Subsequent numbers in the authenticating sequence may be similarly generated, for example, such that the initial authenticating pseudorandom number or a subsequent derivative thereof is input into the cryptographic algorithm to output a next authenticating pseudorandom number of the authenticating sequence. That is, each authenticating pseudorandom number (following the initial authenticating pseudorandom number) is generated by inputting a previous authenticating pseudorandom number into cryptographic algorithm. For example, a second authenticating pseudorandom number is generated as output by inputting the initial authenticating pseudorandom number into the cryptographic algorithm 300; a third authenticating pseudorandom number is generated as output by inputting the second authenticating pseudorandom number into the cryptographic algorithm 300, and so on. The cryptographic algorithm 300 is further described herein for FIG. 3.

At block 164, method 160 comprises generating, by the 2D code printing app, a first dot code based on a first set of one or more pseudorandom numbers in the authenticating sequence.

At block 166, method 160 comprises generating, by the 2D code printing app, a second dot code based on a second set of one or more pseudorandom numbers in the authenticating sequence.

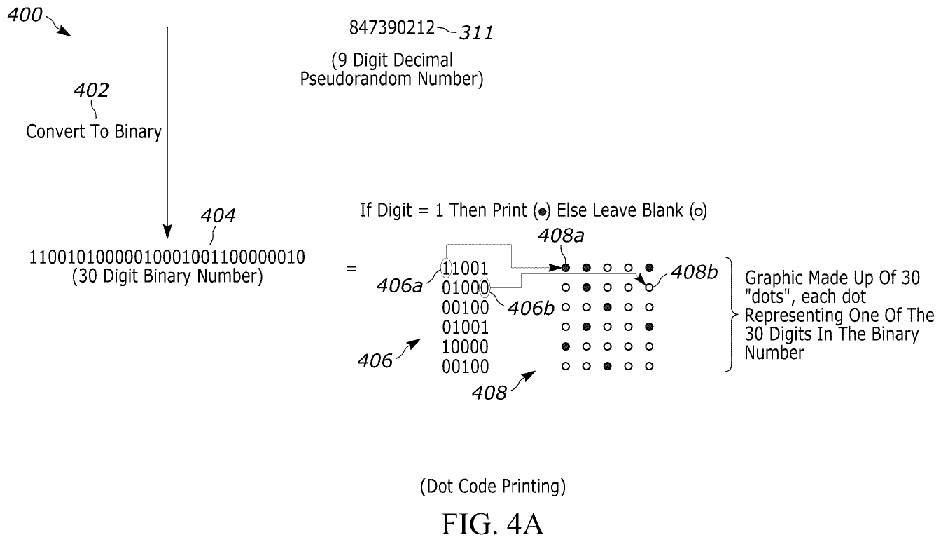

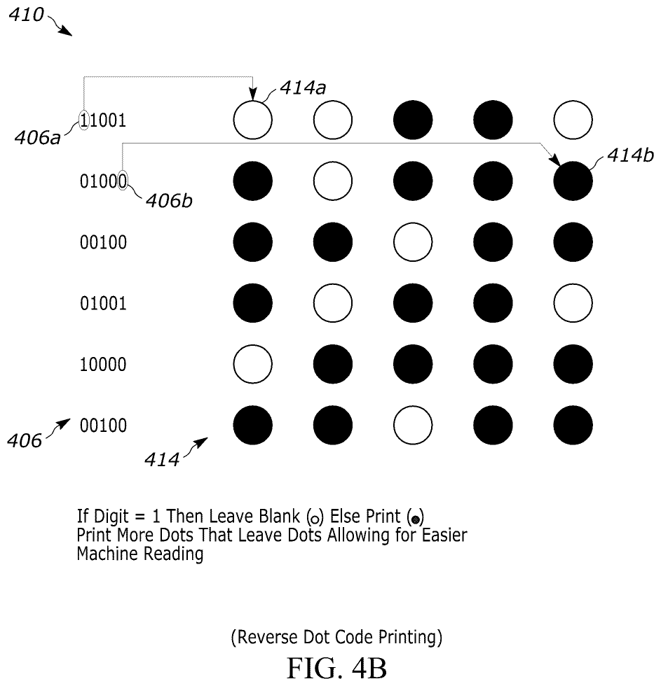

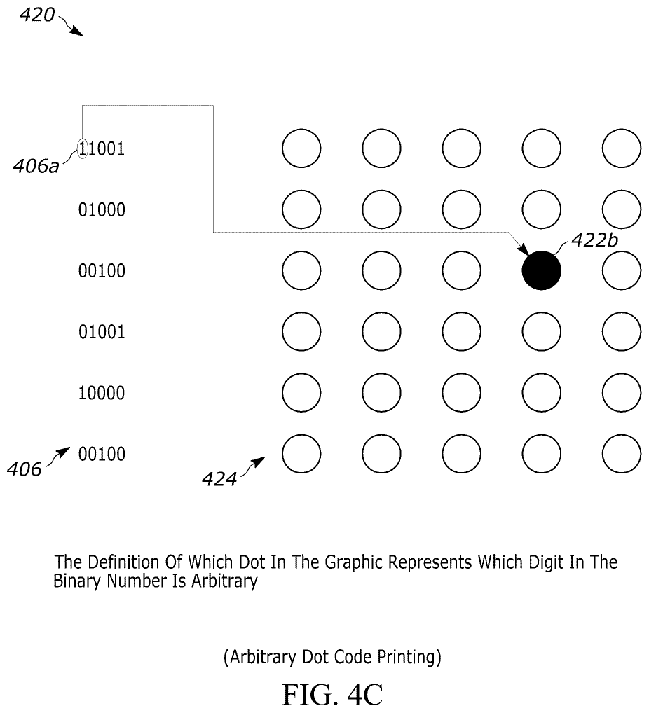

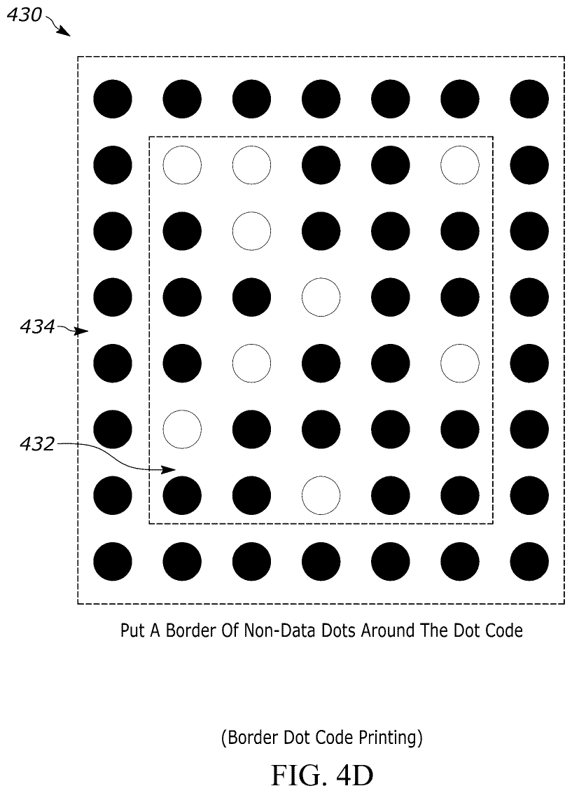

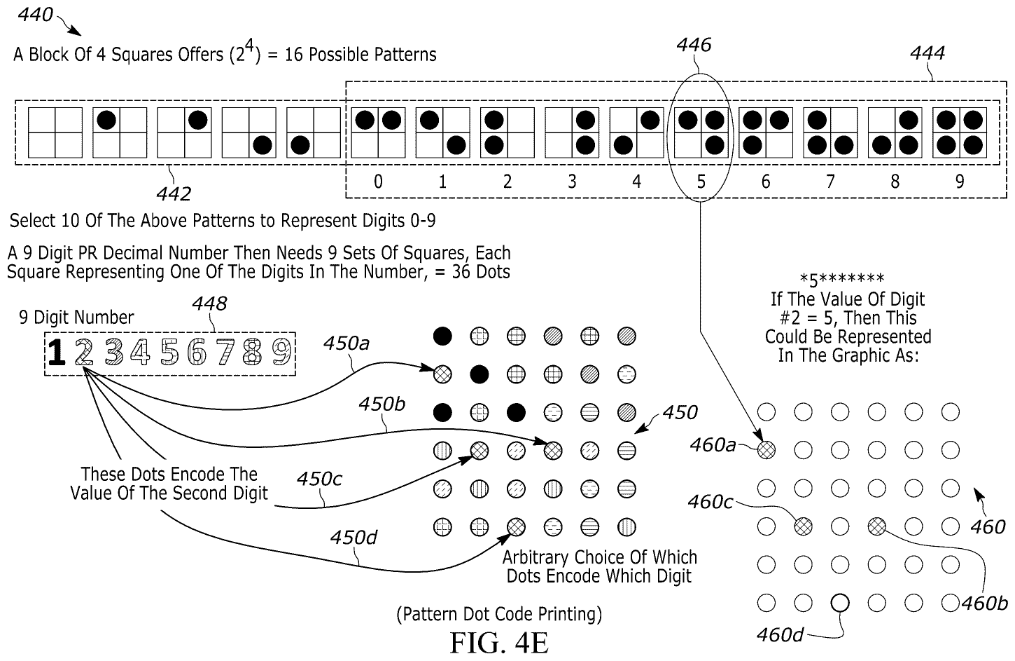

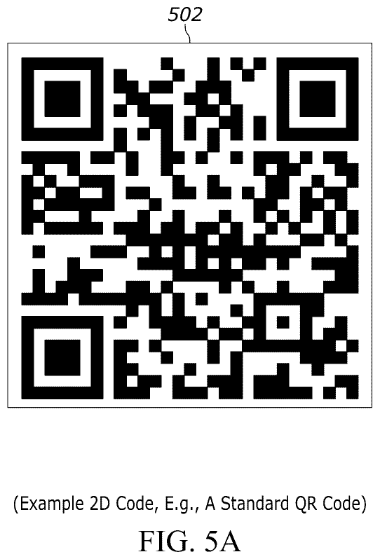

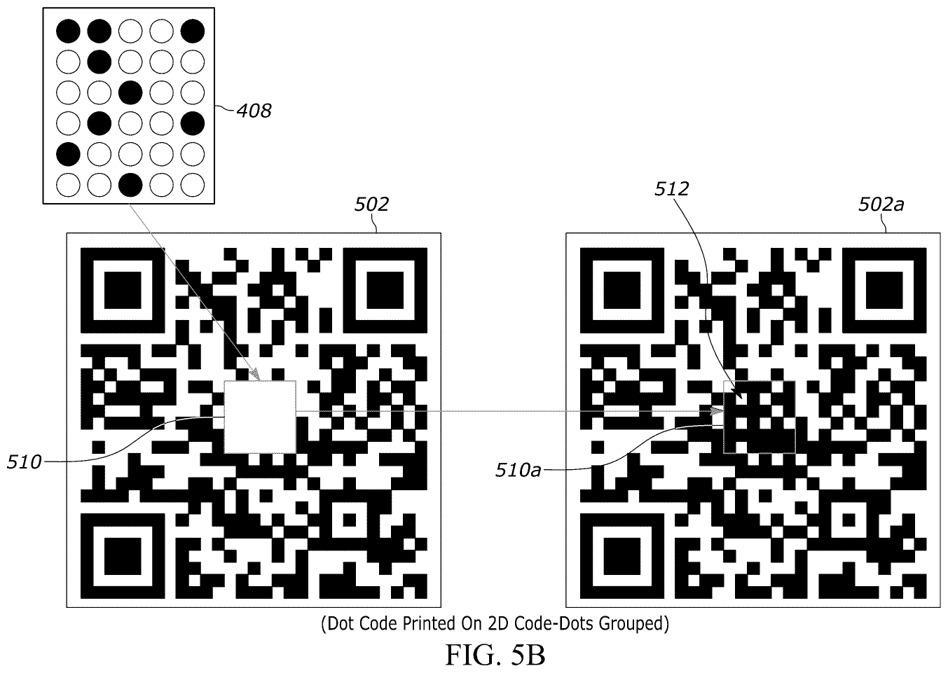

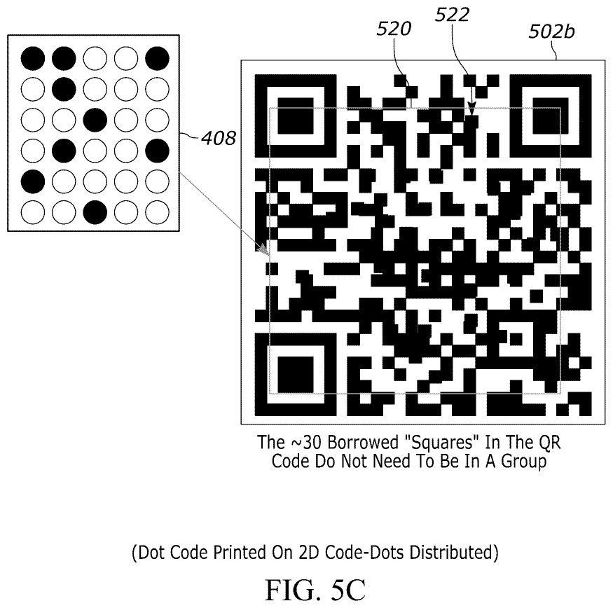

In some aspects, a first dot of the first dot code can comprise a printable unit area within the first 2D code. Similarly, in such aspects, a second dot of the second dot code can comprise a printable unit area within the second 2D code. Such printable unit area(s) are described and illustrated, by way of none-limiting example, in FIGS. 4A-4E and FIGS. 5A-5C.

More generally, a dot in a dot code can refer to a circular dot, or, more generally, to a printable unit having a defined area or shape. By way of non-limiting example, a dot may comprise a rectangle area or shape, or otherwise a rectilinear area or shape. In some examples, a dot may comprise a rectangle area or shape, or otherwise a rectilinear area or shape that can be printed on or within a 2D code (e.g., QR code) so as to be detectable, imageable, or otherwise viewable within a 2D code (e.g., QR code). Examples of dots are shown, in a non-limiting manner, in FIGS. 4A-4E and FIGS. 5B and 5C.

At block 168, method 160 comprises controlling, by the one or more processors (e.g., CPU 104 and/or CPU 134 of FIG. 1A), a printer (e.g., printer 130) to print the first dot code on the first 2D code of the first product.

At block 169, method 160 comprises controlling, by the one or more processors (e.g., CPU 104 and/or CPU 134 of FIG. 1A), a printer (e.g., printer 130) to print the second dot code on the second 2D code of the second product.

In various aspects, the printer 130 may be controlled by printing software (i.e., computing instructions) implemented by a processor (e.g., CPU 134) collocated with the printer 130. Additionally, or alternatively, printer 130 may be controlled by printing software (i.e., computing instructions) implemented by a processor (e.g., CPU 103) remote from the printer 130, e.g., across a computer network (e.g., computer network 120). The printing software can use a decimal number (e.g., a pseudorandom number which may comprise a 9 digit decimal number) generated from the authenticating sequence to print or otherwise encode the decimal number into a dot code, e.g., a pattern of dots, where each dot is printer or not printed based the value of the decimal number and/or a binary number generated therefrom, e.g., as described herein. Such implementations are shown and described by FIGS. 5B and 5C herein.

In this way, generation of the pseudo-random numbers for a product batch could be, in one aspect, implemented by a printer and its related processor. However, in another additional or alternative aspect, a set of pseudorandom numbers and their graphical representations (e.g., dot code and/or QR code) are generated elsewhere, e.g., on a computer in a production plant and/or downloaded from a remote server, e.g., server(s) 102. In such remote implementations, the printer would receive, e.g., over computer network 120, a set of pseudorandom numbers or otherwise information to print respective dot codes and/or QR codes. In such implementations, a printer would not need to implement by itself the printing software configured to generate dot codes for printing or otherwise encoding a decimal number into a dot code onto a given set of products, e.g., a product batch.

FIG. 1C further illustrates a method 170 for authenticating products based on dot codes printed thereon as described for method 160 of FIG. 1B, in accordance with various aspects disclosed herein. At block 172, method 170 comprises determining, by an authentication application (app) (e.g., authentication app 109) comprising instructions configured to be executed by one or more processors, a suspect pseudorandom number from a 2D code printed on a suspect product. The authentication app may comprise a progressive web app (PWA) comprising instructions (e.g., JavaScript code) for executing by a web browser. Additionally, or alternatively, the authentication app may comprise computing instructions configured for a mobile operating system (e.g., Apple IOS), where the authentication app is installable and executable on a mobile device. Additionally, or alternatively, the authentication app may comprise computing instructions configured for a server or cloud-based operating system (e.g., a MICROSOFT or LINUX based operating), where the authentication app is installable and executable on a computing device implementing the operating system, such as a server or cloud-based system or server farm.

At block 174, method 170 comprises determining, by the authentication app (e.g., authentication app 109), a seed value by analysing one or more printed areas at respective predefined locations as printed on the suspect product. For example, the one or more printed areas may comprise, by way of non-limiting example, at least a portion (e.g., defined area 510 as shown for FIG. 5B) of a 2D code 502, at least a portion (e.g., any portion of initial seed value 201) of a batch code 200; and/or (c) at least a portion (e.g., dot 512) of a dot code (e.g., dot code 408 as shown for FIG. 5B).

In various aspects, the seed value could be information obtained from a surface of the suspect product. For example, the information by be captured by analysing an image captured of the suspect product. The suspect product may be positioned on a shelf and/or in a warehouse (or other storage location) at a retail location. For example, as shown for FIG. 1A, a user can capture of an image of the suspect batch code on the suspect product using a camera of a user computing device (e.g., computing device 112c1).

In some aspects, authentication app 109 comprises computing instructions of a mobile app (e.g., mobile app 110) configured to be executed by a device processor of a mobile device (e.g., mobile device 112c1), wherein the computing instructions, when executed by a device processor of the mobile device, is configured to cause the device processor to capture, by a camera of the mobile device, an image comprising the 2D code and/or the one or more printed areas at respective predefined locations. In such example, the 2D code and/or the one or more printed areas at respective predefined locations may comprise suspect batch code information as printed on the suspect product. In such aspects, the seed value may be determined from the image comprising the suspect batch code information. In some aspects, the suspect batch code information may be included in the 2D code printed on the suspect product.

In various aspects, the seed value may comprise any one or more of initial seed value 201, initial seed value 250 (printed product surface information), initial seed value of dot code 408 from augmented 2D code 502b, and/or initial seed value of dot code 408 of grouping of dots 510a, as shown and described herein for FIGS. 2A and 2B. Additionally, or alternatively, the seed value may comprise or further comprise one or more values associated with the suspect product selected from, for example: a manufacturing plant ID code, manufacturing line information, or batch number information.

At block 176, method 170 comprises generating, by the authentication app (e.g., authentication app 109), a test sequence of test pseudorandom numbers (e.g., sequence 310) by inputting the seed value into the cryptographic algorithm to output an initial test pseudorandom number in the test sequence. Each subsequent test pseudorandom number in the test sequence is generated directly or indirectly from the initial test pseudorandom number such that the initial test pseudorandom number or a subsequent derivative thereof is input into the cryptographic algorithm to output a next test pseudorandom alphanumeric number of the test sequence.

In various aspects, the test sequence can be generated in the same manner as the authenticating sequence described herein for block 162 of method 160. That is, each subsequent test pseudorandom number in the test sequence may be generated directly or indirectly from the initial test pseudorandom number whereby the initial test pseudorandom number or a subsequent derivative thereof is input into the cryptographic algorithm to output a next test pseudorandom alphanumeric number of the test sequence. That is, each test pseudorandom number (following the initial test pseudorandom number) is generated by inputting a previous test pseudorandom number into cryptographic algorithm. For example, a second test pseudorandom number is generated as output by inputting the initial test pseudorandom number into the cryptographic algorithm 300, a third test pseudorandom number is generated as output by inputting the second test pseudorandom number into the cryptographic algorithm 300, and so on. The cryptographic algorithm 300 is further described herein for FIG. 3.

When a cryptographic algorithm is configured (e.g., has the same parameters) for generation of a test sequence as it had been configured for generating the authenticating sequence, then the output of the cryptographic algorithm will be the same (e.g., will result in the same sequence). In this way, the test sequence, at least in aspects where the test seed value is an authentic seed (e.g., an authentic date), then generation of the test sequence may be considered as a reverse engineered or reconstructed sequence that is bootstrapped from the seed value alone. This improves over existing systems because memory resources (e.g., memory 106 and/or database 105) are freed from having to store records of authentic codes. Instead, authentication and counterfeit detection may be determined based on the initial seed value, test seed value, and/or cryptographic algorithm without the requirement storing authentic codes in memory.

At block 177, method 170 comprises generating, by the authentication app (e.g., authentication app 109), an output comprising one of two outputs. For example, at block 178 a first output comprises an authenticating output indicating that the suspect product is authentic when the suspect pseudorandom number matches a test alphanumeric pseudorandom number derived from at least one test pseudorandom number of the test sequence.

At block 179, a second output comprises a counterfeit output indicating that the suspect product is counterfeit when the suspect pseudorandom number fails to match a test alphanumeric pseudorandom number derived from at least one test pseudorandom number of the test sequence.

The outputs are specific to the product being imaged, scanned, detected, or otherwise inspected, e.g., by a user using a computing device (e.g., computing device 112c1) to capture an image of a product. For example, in various aspects, a mobile application (app) (e.g., mobile app 110) comprising computing instructions configured to be executed by a device processor of a mobile device (e.g., computing device 112c1) can be executed by the device processor to capture, by a camera or scanner of the mobile device (e.g., computing device 112c1), an image or scan data of a batch code (e.g., a suspect 2D code and/or dot code) as printed on a suspect product. An identified product date and/or otherwise seed value may be determined from the image or scan data of the 2D code. For example, the image or scan data may be analysed to extract the 2D code, including the suspect alphanumeric number. Image extraction of the suspect alphanumeric number may be performed via optical character recognition (OCR) or scanning, although it is to be understood that additional and/or different imaging methods may be used.

In some aspects, generation of the output may further comprise submitting one or both of the suspect batch code information and the suspect pseudorandom number to an authentication database comprising a list of known counterfeit pseudo-random codes (e.g., a “bad list” of codes). In such aspects, the counterfeit output is provided in response (e.g., to the mobile app 110) when the one or both of the suspect batch code and the suspect pseudorandom number match at least one known counterfeit pseudo-random code identified within the known counterfeit pseudo-random codes. Alternatively, the authenticating output is provided in response (e.g., to the mobile app 110) when the one or both of the suspect batch code and the suspect pseudorandom number fail to match at least one known counterfeit batch code within the known counterfeit pseudo-random codes. Such counterfeit and authentication detection may be performed, for example, where it is expected that a counterfeiter may take a subset of valid codes and print them many times on the counterfeited product. Although, it is to be understood, that such determination may be made for other purposes. The authentication database may be a database (e.g., database 105) communicatively coupled to and/or accessible via servers 102. In such aspects, database comprises a list (e.g., bad list) of known copied or counterfeit codes that may include a batch code and/or a pseudorandom number. Authentication app 109 may analyse any such suspect code to detect a counterfeit code by comparing the code to a listing of known counterfeit codes in the database (e.g., database 105).

The authentication app 109 can be executed to check whether one or more of the codes (e.g., batch code and/or pseudorandom number) is found in the known counterfeit codes. The counterfeit output is provided in response (e.g., to the mobile app 110) when a given code is not found in the image or otherwise fails to match at least one known counterfeit batch code identified within the known counterfeit pseudorandom codes. Alternatively, the authenticating output is provided in response (e.g., to mobile app 110) when a given code fails to match at least one of the authenticating sequence of codes (e.g., sequence 310).

FIG. 2A illustrates an example information for an initial seed value 201 in accordance with various aspects disclosed herein. In the example of FIG. 2A, initial seed value 201 comprises one or more values associated with a product batch code 200, including a product date (202), a manufacturing plant ID code (204), manufacturing line information (206), or other such batch number information. In various aspects, such information may be printed on a surface of the product. Such information may comprise batch code information of the given product, which comprises information about where and when the product was manufactured. It is to be understood, however, that additional and/or different values, information, and/or data may be used for, or for determining, an initial seed value.

In the example of FIG. 2A, batch code 200 may be printed on a product by a printer (e.g., printer 130). Batch code 200 comprises a date of manufacture 202 (e.g., “1027”). The date of manufacture represents a date when the product (e.g., a bottle of shampoo) was manufactured, which is Jan. 27, 2021, in the example of FIG. 2A. In addition, batch code 200 comprises a plant code 204 (e.g., plant “4843”), which indicates an identifier of the plant where the product was manufactured. Still further, batch code 200 comprises line info 206 (e.g., line number 10), which indicates an identifier of the line for which the product was manufactured.

As shown in the example of FIG. 2A, each of the date of manufacture 202, the plant code 204, and the line number 10 may comprise an initial seed value (e.g., initial seed value 201). For example, as shown, these values may be used to create a seed value for generation of a sequence (e.g., sequence 310) of pseudorandom numbers (e.g., these could be either for the authentic pseudorandom numbers and/or the test pseudorandom numbers as described herein). By incorporating the date into the seed value, a key advantage arises in that, for every day in the calendar year, there is a different subset of unique pseudorandom numbers for that day. The date of the next day can be used to yield another different unique sets of codes, and so on. Use of the date value reduces the requirement of storage and memory utilization (e.g., memory 106 and/or database 105) of pseudorandom numbers.

FIG. 2B illustrates a further example of information for an initial seed value, in accordance with various aspects disclosed herein. In the example of FIG. 2B, and at least in one aspect, the initial seed value may comprise a value determined from analysing one or more printed areas at respective predefined locations on a surface of the first product. In such aspects, the dotcode or otherwise borrowed pixels of a given surface (e.g., which may contain a QR code) can be used to generate and/or regenerate an initial seed value thereby enabling the seed value to come from anywhere on the product, e.g., as shown for FIG. 2B herein.

Such implementation may comprise, by way of non-limiting example, an initial seed value 250 as determined from information printed on the surface of the product. Additionally, or alternatively, an initial seed value of a dot code (e.g., dot code 408 of FIG. 4A comprising a grouping of dots 510a) can be included in a dot code and hence read from the dot code. That is, grouping of dots 510a can be used as an initial seed value and can be determined from analysing a dot code of a given product, e.g., a dot code 408 as shown for FIGS. 4A-4E and 5A-5C described herein. In such aspects, the seed value can be included in a dot code (e.g., dot code 408) and hence read from the dot code by a computing device, e.g., computing device 112c1.

In some aspects, the information in the dot code (e.g., dot code 408) may comprise a same set of information as initial seed value 201 described for FIG. 2A. Additionally, or alternatively, the information in the dot code (e.g., dot code 408) may comprise different and/or additional information, such as random or arbitrary information based on the positioning of the dots in the dot code.

FIG. 3 illustrates an example cryptographic algorithm used to generate a sequence 310 of pseudorandom alphanumeric numbers, in accordance with various aspects disclosed herein. With reference to FIG. 3, cryptographic algorithm 300 is shown as a formula:

Xₙ₊₁=MODₘ[a*Xₙ+b]

In cryptographic algorithm 300, X₁ (the initial value of Xₙ) comprises an initial (seed) number, which may be determined from an initial seed value, such as any of the initial seed values or other information, e.g., as shown and described for FIGS. 2A and 2B, or elsewhere herein. Further, in cryptographic algorithm 300, Xₙ is the n^{th} number in a given sequence, whereby the n^{th} pseudorandom number or a subsequent derivative thereof is input into the cryptographic algorithm 300 to output a next pseudorandom number (Xₙ₊₁) of the sequence.

Still further, for cryptographic algorithm 300, MODₘ is the modulo function applied with modulus value m, where m may comprise a prime number (e.g., 120767). The modulo operation returns the remainder or signed remainder of a division operation, after the output of the calculation [a*Xₙ+b] is divided by the modulus m. Because of the modulo operation, the output of cryptographic algorithm 300 (defined by Xₙ₊₁), and therefore the series defined by cryptographic algorithm 300, will repeat after m−1 numbers. Because of this, the value of m will define an approximate maximum batch size.

Further, in the cryptographic algorithm 300, values a and b may comprise integer values, which may be any integer values. For example, the values chosen for example cryptographic algorithm 300 may comprise, e.g., a=83, b=52, m=120767, where these values determine the output of cryptographic algorithm 300 (defined by Xₙ₊₁), which is next pseudorandom number in the sequence.

In some aspects, the values of a and/or b can be changed or updated, e.g., by computing instructions controlling printer 130 and/or the 2D code printing app 108 at periodic intervals so as to provide additional security against a counterfeiter determining or reverse engineering the formula for creating the sequence of pseudorandom numbers (e.g., cryptographic algorithm 300).

Cryptographic algorithm 300 may be implemented or executed by processor(s) 104, and be a part of, or assessed by, 2D code printing app 108. Cryptographic algorithm 300 may be used to generate a sequence of pseudorandom numbers. Examples of the sequence of pseudorandom numbers include the authenticating sequence of authentic pseudorandom numbers, and the sequence of test pseudorandom numbers as described herein, e.g., for method 160 of FIGS. 1B and 1C. Each pseudorandom number in the sequence may then be converted into a dot code (e.g., such as dot code as described herein for FIGS. 4A-4E, 5B, and 5C). In this way, a first pseudorandom number is generated, and can then be used to create the second pseudorandom number, so on. These pseudorandom numbers determine the value, configuration, or otherwise appearance of a code (e.g., a dot code), for example, as described herein. While FIG. 3 illustrates one example of a cryptographic algorithm, it should be understood that other cryptographic algorithms, in addition to, or different from, example cryptographic algorithm 300 may be used.

In various aspects, cryptographic algorithm 300 uses the initial seed value (e.g., initial seed value 201 or grouping of dots 510a) as input (a starting point) to cryptographic algorithm 300 and calculates a pseudo random sequence (e.g., sequence 310) of numbers. Each number in the pseudo random sequence (e.g., sequence 310) may be used to choose alphanumeric values and dot codes, based on the dot code pattern or otherwise dot code printing algorithm as described herein for FIGS. 4A-4E, 5B, and 5C.

With further reference to FIG. 3, sequence 310 is a sequence of pseudorandom numbers generated based on pseudorandom numbers as output by cryptographic algorithm 300. In particular, sequence 310 may be generated by 2D code printing app 108, printer processor 134, or other processor (e.g., processor(s) 104) and represents pseudorandom numbers based on the authenticating pseudorandom numbers as output by cryptographic algorithm 300.

Sequence 310 comprises a first pseudorandom number 311 (e.g., “847390212”), a second pseudorandom number 312 (e.g., “357344614”), a third pseudorandom number 313 (e.g., “312546596”), a fourth pseudorandom number 314 (e.g., “564985347”), and next (“n^{th}” set) pseudorandom numbers 315 (represented by place holder “ . . . ”), which would be a next pseudorandom number generated in the sequence by cryptographic algorithm 300.

Each pseudorandom number of sequence 310 may be printed on a product (e.g., a shampoo bottle as shown for FIG. 3). In addition, at least in some aspects, products may be included as part of a product batch (e.g., product batch 150). For example, one or more of a first product 151, a second product 152, a third product 153, a fourth product 154, a fifth product 155, and so on (e.g., additional products) may be packages as part of a product batch (e.g., product batch 150). Each of the products may have printed thereon (e.g., by printer 130) a sequence (e.g., sequence 310) of pseudorandom numbers, e.g., as determined based on the cryptographic algorithm 300. In this, way pseudorandom numbers from a given set of products (e.g., product batch 150) may be packaged, boxed, or otherwise grouped together and may be identifiably related based on a family or group of related pseudorandom numbers. For example, given a pseudorandom number (e.g., “847390212”) on one product (e.g., product 151) in a product batch (e.g., product batch 150), it can be determined what the codes for the remaining products in the batch should be.

For example, where first product 151, second product 152, third product 153, fourth product 154, fifth product 155 comprise a box of products or product batch (e.g., product batch 150), then each of those products would be expected to have a sequence of codes based on output by cryptographic algorithm 300. Any product not conforming to the sequence could be identified as counterfeit. For example, if one product was swapped out of the box of products, then it would be identifiable that the swapped product is invalid or counterfeit because the invalid or counterfeit product would not have a valid code in the sequence 310. This could help address a common tactic by counterfeiters who mix counterfeit with genuine product.

Further, in various products (e.g., a first product and second product, etc.) may be packaged as part of a package or unit of products each having associated with an authentic pseudorandom number selected from the authenticating sequence of authentic pseudorandom numbers. Given that pseudorandom numbers are defined in a sequence, then ordering (or disordering) of products can also be determined. For example, in sequence 310, pseudorandom number (“357344614”) should come after “847390212.” In a box of multiple products, the products can be ordered based on codes, where it can later be identified whether one or more products in the box have been replaced and/or disordered.

FIG. 4A illustrates an example dot code printing algorithm 400 in accordance with various aspects disclosed herein. In the example of FIG. 4A, dot code printing algorithm 400 converts (402) pseudorandom number 311 to a binary number 404. Binary number 404 is then used to generate dot code 408. In the example of FIG. 4A, binary number 404 is a 30-digit binary number because it is the binary representation of the 9 digit decimal pseudorandom number 311. However, it should be understood that different sizes of digits, binary numbers, or other lengths of values could be used.

More generally, as shown for FIG. 4A, a dot code (e.g., dot code 408 or other dot codes as described for FIGS. 4B-4E) comprises a matrix of dots, e.g., having rows and columns of dots, or as otherwise shown or described herein. Each dot represents a digit in the binary number 404. In various aspects, a pseudorandom number can be determined from a dot code by retrieving an image of the dot code and reversing implementation of the algorithm in FIG. 4A (or by reversing another algorithm as shown herein for any one or more of FIGS. 4B-4E). Such determined pseudorandom number may be compared to an authentic or test an alphanumeric number derived from at least one test pseudorandom number of a sequence of an authenticating or test sequence as described herein. If the pseudorandom alphanumeric number matches an authentic alphanumeric number, then an authenticating output may be generated. Otherwise, a counterfeit output may be generated as described herein.

With further reference to FIG. 4A, computing instructions of the 2D code printing app (e.g., 2D code printing app 108), when executed by the one or more processors, may be configured to cause the one or more processors to covert at least one pseudorandom number (e.g., pseudorandom number 311) of a first set of one or more pseudorandom numbers into a binary number (e.g., binary number 404). The binary number having a plurality of binary digits (e.g., 30 digits as shown for FIG. 4A). Each dot (e.g., 408a, 408b) of a given dot code (e.g., dot code 408) could then correspond to a binary digit (406a, 406b) of the plurality of binary digits.

For example, as shown for FIG. 4A, dot code 408 is comprised of 30 dots, each dot representing one of the 30 digits in the binary number 404. For example, a first digit 406a in binary number 404 could represent a first dot 408a in dot code 408. As a further example, a second digit 406b in binary number 404 could represent a second dot 408b in dot code 408, and so on.

In various aspects, the dots of a given dot code can be coloured, shaped, or otherwise distinguished based on the values of the digits in the binary number 404. For example, as shown in dot code 408, black or dark dots are generated for binary digits having a value of 1. White or non-coloured (blank) dots are generated for binary digits having a value of 0.

FIG. 4B illustrates an example reverse dot code printing algorithm 410 in accordance with various aspects disclosed herein. In the example of FIG. 4B, dot code 414 is generated in the similar manner as dot code 408 where dot code 414 is comprised of 30 dots, where each dot represents one of the 30 digits in the binary number 404. For example, a first digit 406a in binary number 404 could represent a first dot 414a in dot code 414. As a further example, a second digit 406b in binary number 404 could represent a second dot 414b in dot code 414, and so on.

However, in the example of FIG. 4B, reverse dot code printing algorithm 410 comprises reversing a representation of each dot such that each dot of the dot code corresponds to a reverse value of a binary digit (414a, 414b) of the plurality of binary digits. Thus, in the example of FIG. 4B, the dots of a given dot code can be coloured, shaped, or otherwise distinguished based on the values of the digits in the binary number 404. For example, as shown in dot code 408, black or dark dots are generated for binary digits having a value of 0. White or non-coloured (blank) dots are generated for binary digits having a value of 1.

In some aspects, the reverse dot code printing algorithm 410 can cause more black or dark dots to be printed thus making a given dot code (e.g., dot code 414) easier to read by a scanning device, e.g., a mobile device 112c1.

FIG. 4C illustrates an example arbitrary dot code printing algorithm 420 in accordance with various aspects disclosed herein. In the example of FIG. 4C, dot code 424 is generated in the similar manner as dot code 408 where dot code 424 is comprised of 30 dots, where each dot represents one of the 30 digits in the binary number 404. For example, a first digit 406a in binary number 404 could represent a first dot 422a in dot code 424.

In the example of FIG. 4C, arbitrary dot code printing algorithm 420 comprises defining or printing each of the one or more dots (e.g., dot 422b) of dot code 424 at an arbitrarily position(s) within the dot code. In this way, instead of sequential placement (as demonstrated for the examples of FIGS. 4A and 4B), the dot code positions of dot code 424 are arbitrary mapped within dot code 424. A map of the arbitrary placement or positioning of the dots may be saved in memory (e.g., memory 106) in order to reverse engineer related binary number 404, and pseudorandom number 311, which cand then be sued to authenticate or test for counterfeiting a given product, e.g., as described herein.

FIG. 4D illustrates an example border dot code printing algorithm 430 in accordance with various aspects disclosed herein. In the example of FIG. 4D, border dot code printing algorithm 430 causes printer to print a border 434 of non-data dots around a dot code (e.g., dot code 432), such that the dot code comprises a border of non-data dots. Dot code 432 may comprise any one of the dot codes described, by way of non-limiting example, for FIGS. 4A-4C or elsewhere herein. The non-data dots are dots that are not associated with any digit of a binary number 404 (e.g., binary number 404). The border 434 of non-data dots can assist a scanning computing device (e.g., a computing device such as computing device 112c1) delineate, detect, or otherwise identify a dot code on the surface of a product, where the scanning computing device is configured to search for and/or detect border 434 within an image to clearly define the dot code (e.g., dot code 432) within. In this way, the efficiency of and/or capability to correctly identify dot codes by the scanning computing device is enhanced.

FIG. 4E illustrates an example pattern dot code printing algorithm 440 in accordance with various aspects disclosed herein. In the example of FIG. 4E, a series of block patterns 444 are selected from a set of block patterns 442. In the example of FIG. 4E, block patterns 442 comprise a set of 16 possible block pattern with each dot having a position (or lack thereof) within a given block pattern. A series of 10 block patterns (e.g., block patterns 444) are selected from an end of the set of block patterns 442. It should be noted that different lengths or sizes of block patterns may be used, and that different positions within a given block pattern may be chosen. Each block pattern in the series of block patterns 444 represents a number value 446 (e.g., a number or value of 0-9) in a pseudorandom number (e.g., pseudorandom number 311). In this way, each block pattern can represent a number in a given pseudorandom number (e.g., pseudorandom number 311). For example, pseudorandom number 311 is a 9-digit number, as presented by number 448 which can be represented by each series of block patterns 444.

Each position of a digit in the 9-digit number 448 could map to an arbitrary position within a dot code (e.g., dot code 450). For example, as shown for FIG. 4E, the digit at position number 2 in 9-digit number 448 maps or is otherwise encoded at specific locations 450a, 450b, 450c, and 450d in dot code 450. Then, when the value for the 9-digit number 448 is supplied at the specific position, such value can be mapped or coded at the specific locations. For example, as shown for FIG. 4E, if the value of digit at position 2 is the value of 5, the pattern of dots (or lack thereof) of the block pattern 5 of the series of block patterns 444 can be mapped or encoded at the specific locations of dotcode 460 corresponding to position 2 of 9-digit number 448. Values 460a, 460b, 460c, and 460c from block pattern 5 are shown as mapped or encoded onto specific locations 450a, 450b, 450c, and 450d to create block code 460.

In various aspects, and with reference to the FIG. 4E as a non-limiting example, computing instructions of the 2D code printing app (e.g., 2D code printing app 108), when executed by one or more processors (e.g., processor(s) 104), are further configured to cause the one or more processors to generate a series of block patterns 444. Each block pattern represents a number value 446. Further, each block pattern defines a dot pattern comprising: (a) one or more dots; and/or (b) an absence of one or more dots.

The 2D code printing app (e.g., 2D code printing app 108) may assign a position within a dot code (e.g., dot code 450) for each digit of a pseudorandom number (e.g., 9-digit number 448) of a first set of one or more pseudorandom numbers. For each digit of a pseudorandom number (e.g., pseudorandom number 311), the 2D code printing app (e.g., 2D code printing app 108) may print each dot of the dot code by applying the dot pattern of a number value (e.g., number value 446) at the position of the digit assigned within the dot code (e.g., dot code 450).

FIG. 5A illustrates an example 2D code 502, in accordance with various aspects disclosed herein. In the example of FIG. 5A, 2D code 502 is represented as a QR code. It is to be understood, however, that other 2D codes, such as 2D data matrix codes, as a non-limiting example, may be used in the alternative. Further, by non-limiting example, a data matrix code can be a code defined by one or more of the Data Matrix ECC standards, or an ISO/IEC Data Matrix standard, including, for example, any one or more of ISO/IEC 16022:2006, ISO/IEC 15415, or the like.

FIG. 5B illustrates an example dot code (e.g., dot code 408) as printed on the 2D code (e.g., 2D code 502) of FIG. 5A, in accordance with various aspects disclosed herein. As shown for FIG. 5B, dot code 408 is printed on a portion (e.g., defined area 510) of 2D code 502 of a 2D code 502, thereby superimposing or otherwise covering 2D code 502 with the dot code 408 to create a new or otherwise augmented 2D code 502a. The dot code 408 comprises a grouping of dots 510a, including dot 512, as printed within or on 2D code 502a. That is, as shown in the example of FIG. 5B, dot code 408 is printed as a grouping of dots 510a in a defined area 510 of the augmented 2D code 502a. 2D code 502a can be printed on a product, e.g., product 151.

In the example, of FIG. 5B, dot code 408 is illustrated as a predefined matrix, arrangement, or pattern of dots (e.g., dots from dot code 408). More generally, a dot code can refer to a matrix or otherwise arrangement or pattern of dots. The matrix or otherwise arrangement or pattern of dots of a dot code can be a predefined matrix or otherwise arrangement or pattern. Still further, the matrix or otherwise arrangement or pattern of dots of a dot code can have a predefined location or placement within a perimeter of a 2D code (e.g., a QR code).

In one aspect, a 2D code (e.g., augmented 2D code 502a) may comprise a QR code and a dot (e.g., dot 512) of the given dot code comprises a module of the 2D code. With respect to a QR code, a module refers the fundamental unit of a QR code. Modules comprise black-and-white blocks that make up the data encoded in a QR Code. Modules store data and make up the rows and columns of the QR Code, which may also be called a data matrix.

FIG. 5C illustrates a further example dot code 408 as printed on the 2D code of FIG. 5A, in accordance with various aspects disclosed herein. In the example of FIG. 5C, dot code 408 is printed as a distributed set of dots 520 where each dot (e.g., dot 522) of the distributed set of dots has a predefined location within the given 2D code (e.g., augmented 2D code 502b). Each of the dots in the distributed set of dots do not need to be in a group and have known, distributed locations so they can be detected when the 2D code is scanned or otherwise imaged, e.g., by a camera of computing device 112c1. The augmented 2D code 502b can be printed on a product, e.g., product 151.

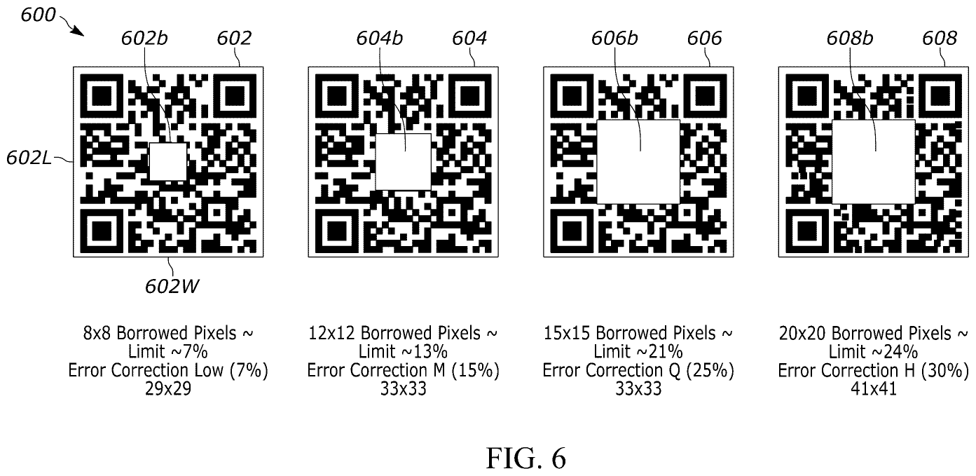

FIG. 6 illustrates example 2D codes 600 each defining a percentage of pixels than can be missing in accordance with various aspects disclosed herein. As shown for FIG. 6, each of 2D codes 600 has a resolution defined in pixels having a pixel length and a pixel width. For example, 2D code 602 has a defined pixel length 602L and a pixel width 602W.

Each of the 2D codes 600 has or otherwise corresponds to an error correction value that defines a percentage of pixels (e.g., 7% for 2D code 602, 15% for 2D code 604, 21% for 2D code 606, and 24% for 2D code 608) than can be missing from 2D code while allowing the 2D code to remain scannable. A dot code may be printed on a given 2D code covering an area of pixels equal to or less than the percentage of pixels that can be missing. For example, the maximum or percentage of pixels that can be missing for each of 2D code 602, 2D code 604, 2D code 606, and 2D code 608 are shown by the areas 602b, 604b, 606b, and 608b, respectively. As one example, the area of pixels for printing the first dot code comprises an area having a 12 pixel length and a 12 pixel width, which presents the area of 2D code 604 that can receive a dot code (e.g., dot code 408) that can be missing from 2D code while allowing the 2D code to remain scannable, e.g., by a camera of a computing device, e.g., computing device 112c1.

### ASPECTS OF THE DISCLOSURE

The following aspects are provided as examples in accordance with the disclosure herein and are not intended to limit the scope of the disclosure.

Aspect 1. A system configured for product authentication via two-dimensional (2D) codes using dot codes, the system comprising: one or more processors; and a 2D code printing application (app) comprising computing instructions configured to be executed by the one or more processors, wherein the computing instructions of the 2D code printing app, when executed by the one or more processors, are configured to cause the one or more processors to: generate an authenticating sequence of authentic pseudorandom numbers by inputting an initial seed value into a cryptographic algorithm to output an initial authenticating pseudorandom number in the authenticating sequence, wherein the initial seed value corresponds to a first product that is part of a product batch, wherein the first product has a first 2D code printed thereon, wherein a second product has a second 2D code printed thereon, the second product being part of the product batch, wherein each subsequent authenticating pseudorandom number in the authenticating sequence is generated directly or indirectly from the initial authenticating pseudorandom number whereby the initial authenticating pseudorandom number or a subsequent derivative thereof is input into the cryptographic algorithm to output a next authenticating pseudorandom number of the authenticating sequence, generate a first dot code based on a first set of one or more pseudorandom numbers in the authenticating sequence, generate a second dot code based on a second set of one or more pseudorandom numbers in the authenticating sequence, control, by the one or more processors, a printer to print the first dot code on the first 2D code of the first product, and control, by the one or more processors, the printer to print the second dot code on the second 2D code of the second product.

Aspect 2. The system of any of the preceding aspects further comprising: an authentication application (app) comprising instructions configured to be executed by the one or more processors, wherein the computing instructions of the authentication app, when executed by the one or more processors, are configured to cause the one or more processors to: determine a suspect pseudorandom number from a 2D code printed on a suspect product, determine a seed value by analysing one or more printed areas at respective predefined locations as printed on the suspect product, generate a test sequence of test pseudorandom numbers by inputting the seed value into the cryptographic algorithm to output an initial test pseudorandom number in the test sequence, wherein each subsequent test pseudorandom number in the test sequence is generated directly or indirectly from the initial test pseudorandom number whereby the initial test pseudorandom number or a subsequent derivative thereof is input into the cryptographic algorithm to output a next test pseudorandom alphanumeric number of the test sequence, and generate an output comprising one of: (1) an authenticating output indicating that the suspect product is authentic when the suspect pseudorandom number matches a test alphanumeric pseudorandom number derived from at least one test pseudorandom number of the test sequence; or (2) a counterfeit output indicating that the suspect product is counterfeit when the suspect pseudorandom number fails to match a test alphanumeric pseudorandom number derived from at least one test pseudorandom number of the test sequence.

Aspect 3. The system of aspect 2, wherein the authentication app comprises computing instructions of a mobile app configured to be executed by a device processor of a mobile device, wherein the computing instructions, when executed by the device processor, is configured to cause the device processor to: capture, by a camera of the mobile device, an image comprising the 2D code and/or the one or more printed areas at respective predefined locations, the 2D code and/or the one or more printed areas at respective predefined locations comprising suspect batch code information as printed on the suspect product, and determine the seed value from the image comprising the suspect batch code information.

Aspect 4. The system of aspect 3, wherein the suspect batch code information is included in the 2D code printed on the suspect product.

Aspect 5. The system of any of the preceding aspects, wherein the dot code comprises at least one of: (a) a matrix, arrangement, or pattern of dots; (b) a predefined matrix, arrangement, or pattern of dots; and/or (c) a matrix, arrangement, or pattern of dots having a predefined location or placement within a perimeter of the first 2D code or the second 2D code.

Aspect 6. The system of aspect 5, wherein the computing instructions of the 2D code printing app, when executed by the one or more processors, are further configured to cause the one or more processors to: convert at least one pseudorandom number of the first set of one or more pseudorandom numbers into a binary number, the binary number having a plurality of binary digits, wherein each dot of the dot code corresponds to a binary digit of the plurality of binary digits.

Aspect 7. The system of aspect 6, wherein each dot of the dot code corresponds to a reverse value of a binary digit of the plurality of binary digits.

Aspect 8. The system of aspect 6, wherein one or more dots of the dot code are defined at an arbitrarily position within the dot code.

Aspect 9. The system of aspect 5, wherein the dot code comprises a border of non-data dots.

Aspect 10. The system of aspect 5, wherein the computing instructions of the 2D code printing app, when executed by the one or more processors, are further configured to cause the one or more processors to: generate a series of block patterns, wherein each block pattern represents a number value, and wherein each block pattern defines a dot pattern comprising: (a) one or more dots; and/or (b) an absence of one or more dots. assign a position within the dot code for each digit of a pseudorandom number of the first set of one or more pseudorandom numbers, for each digit of a pseudorandom number, print each dot of the dot code by applying the dot pattern of a number value at the position of the digit assigned within the dot code.

Aspect 11. The system of aspect 5, wherein the first dot code is printed as a grouping of dots in a defined area of the first 2D code of the first product.

Aspect 12. The system of aspect 5, wherein the first dot code is printed as a distributed set of dots, wherein each dot of the distributed set of dots has a predefined location within the first 2D code of the first product.

Aspect 13. The system of aspect 3, wherein generation of the output further comprises submitting one or both of the suspect batch code information and the suspect pseudorandom number to an authentication database comprising a list of known counterfeit pseudo-random codes, wherein the counterfeit output is provided in response when the one or both of the suspect batch code and the suspect pseudorandom number match at least one known counterfeit pseudo-random code identified within the known counterfeit pseudo-random codes, and wherein the authenticating output is provided in response when the one or both of the suspect batch code and the suspect pseudorandom number fail to match at least one known counterfeit batch code within the known counterfeit pseudo-random codes.

Aspect 14. The system of any of the preceding aspects, wherein the first product and the second product are packaged as part of a package or unit of products each having associated with an authentic pseudorandom number selected from the authenticating sequence of authentic pseudorandom numbers.

Aspect 15. The system of any of the preceding aspects, wherein the initial seed value further comprises one or more values associated with the first product selected from: a product date, a manufacturing plant ID code, manufacturing line information, or batch number information.

Aspect 16. The system of any of the preceding aspects, wherein the initial seed value comprises at least one of: (a) a value determined from analysing one or more printed areas at respective predefined locations on a surface of the first product; or (b) a value determined from analysing the first dot code of the first product.

Aspect 17. The system of aspect 2, wherein the seed value further comprises one or more values associated with the suspect product selected from: a manufacturing plant ID code, manufacturing line information, or batch number information.

Aspect 18. The system of any of the preceding aspects, wherein a first dot of the first dot code comprises a printable unit area within the first 2D code, and wherein a second dot of the second dot code comprises a printable unit area within the second 2D code.

Aspect 19. The system of any of the preceding aspects, wherein the first 2D code is a first QR code and a first dot of the first dot code comprises a module of the first QR code, wherein the second 2D code is a second QR code and a second dot of the second dot code comprises a module of the second QR code.

Aspect 20. The system of aspect 2, wherein the one or more printed areas comprises: (a) at least a portion of a 2D code; (b) at least a portion of a batch code; and/or (c) at least a portion of a dot code.

Aspect 21. The system of any of the preceding aspects, wherein a resolution of the first 2D code is defined in pixels having a pixel length and a pixel width, wherein the resolution of the first 2D code corresponds to an error correction value that defines a percentage of pixels than can be missing from the first 2D code while allowing the first 2D code to remain scannable, and wherein the first dot code is printed on the first 2D code covering an area of pixels equal to or less than the percentage of pixels that can be missing.

Aspect 22. The system of aspect 21, wherein the area of pixels for printing the first dot code comprises an area having a 12 pixel length and a 12 pixel width.

Aspect 23. The system of any of the preceding aspects, wherein the first dot code comprises a first data matrix code, and/or wherein the second dot code comprises a second data matrix code.

Aspect 24. A method for product authentication via two-dimensional (2D) codes using dot codes, the method comprising: generating, by a 2D code printing application (app) comprising computing instructions configured to be executed by one or more processors, an authenticating sequence of authentic pseudorandom numbers by inputting an initial seed value into a cryptographic algorithm to output an initial authenticating pseudorandom number in the authenticating sequence, wherein the initial seed value corresponds to a first product that is part of a product batch, wherein the first product has a first 2D code printed thereon, wherein a second product has a second 2D code printed thereon, the second product being part of the product batch, wherein each subsequent authenticating pseudorandom number in the authenticating sequence is generated directly or indirectly from the initial authenticating pseudorandom number whereby the initial authenticating pseudorandom number or a subsequent derivative thereof is input into the cryptographic algorithm to output a next authenticating pseudorandom number of the authenticating sequence, generating, by the 2D code printing app, a first dot code based on a first set of one or more pseudorandom numbers in the authenticating sequence, generating, by the 2D code printing app, a second dot code based on a second set of one or more pseudorandom numbers in the authenticating sequence, controlling, by the one or more processors, a printer to print the first dot code on the first 2D code of the first product, and controlling, by the one or more processors, the printer to print the second dot code on the second 2D code of the second product.

Aspect 25. The method of aspect 1 further comprising: determining, by an authentication application (app) comprising instructions configured to be executed by one or more processors, a suspect pseudorandom number from a 2D code printed on a suspect product, determining, by the authentication app, a seed value by analysing one or more printed areas at respective predefined locations as printed on the suspect product, generating, by the authentication app, a test sequence of test pseudorandom numbers by inputting the seed value into the cryptographic algorithm to output an initial test pseudorandom number in the test sequence, wherein each subsequent test pseudorandom number in the test sequence is generated directly or indirectly from the initial test pseudorandom number whereby the initial test pseudorandom number or a subsequent derivative thereof is input into the cryptographic algorithm to output a next test pseudorandom alphanumeric number of the test sequence, and generating, by the authentication app, an output comprising one of: (1) an authenticating output indicating that the suspect product is authentic when the suspect pseudorandom number matches a test alphanumeric pseudorandom number derived from at least one test pseudorandom number of the test sequence; or (2) a counterfeit output indicating that the suspect product is counterfeit when the suspect pseudorandom number fails to match a test alphanumeric pseudorandom number derived from at least one test pseudorandom number of the test sequence.

Aspect 26. The method of aspect 25, wherein the authentication app comprises computing instructions of a mobile app configured to be executed by a device processor of a mobile device, wherein the computing instructions, when executed by the device processor, is configured to cause the device processor to: capture, by a camera of the mobile device, an image comprising the 2D code and/or the one or more printed areas at respective predefined locations, the 2D code and/or the one or more printed areas at respective predefined locations comprising suspect batch code information as printed on the suspect product, and determine the seed value from the image comprising the suspect batch code information.

Aspect 27. The method of aspect 26, wherein the suspect batch code information is included in the 2D code printed on the suspect product.

Aspect 28. The method of aspect 27, wherein the dot code comprises at least one of: (a) a matrix, arrangement, or pattern of dots; (b) a predefined matrix, arrangement, or pattern of dots; and/or (c) a matrix, arrangement, or pattern of dots having a predefined location or placement within a perimeter of the first 2D code or the second 2D code.

Aspect 29. The method of aspect 28, wherein the computing instructions of the 2D code printing app, when executed by the one or more processors, are further configured to cause the one or more processors to: covert at least one pseudorandom number of the first set of one or more pseudorandom numbers into a binary number, the binary number having a plurality of binary digits, wherein each dot of the dot code corresponds to a binary digit of the plurality of binary digits.

Aspect 30. The method of aspect 29, wherein each dot of the dot code corresponds to a reverse value of a binary digit of the plurality of binary digits.

Aspect 31. The method of aspect 29, wherein one or more dots of the dot code are defined at an arbitrarily position within the dot code.

Aspect 32. The method of aspect 28, wherein the dot code comprises a border of non-data dots.

Aspect 33. The method of aspect 28, wherein the computing instructions of the 2D code printing app, when executed by the one or more processors, are further configured to cause the one or more processors to: generate a series of block patterns, wherein each block pattern represents a number value, and wherein each block pattern defines a dot pattern comprising: (a) one or more dots; and/or (b) an absence of one or more dots. assign a position within the dot code for each digit of a pseudorandom number of the first set of one or more pseudorandom numbers, for each digit of a pseudorandom number, print each dot of the dot code by applying the dot pattern of a number value at the position of the digit assigned within the dot code.

Aspect 34. The method of aspect 28, wherein the first dot code is printed as a grouping of dots in a defined area of the first 2D code of the first product.

Aspect 35. The method of aspect 28, wherein the first dot code is printed as a distributed set of dots, wherein each dot of the distributed set of dots has a predefined location within the first 2D code of the first product.

Aspect 36. The method of aspect 26, wherein generation of the output further comprises submitting one or both of the suspect batch code information and the suspect pseudorandom number to an authentication database comprising a list of known counterfeit pseudo-random codes, wherein the counterfeit output is provided in response when the one or both of the suspect batch code and the suspect pseudorandom number match at least one known counterfeit pseudo-random code identified within the known counterfeit pseudo-random codes, and wherein the authenticating output is provided in response when the one or both of the suspect batch code and the suspect pseudorandom number fail to match at least one known counterfeit batch code within the known counterfeit pseudo-random codes.

Aspect 37. The method of aspects 24-36, wherein the first product and the second product are packaged as part of a package or unit of products each having associated with an authentic pseudorandom number selected from the authenticating sequence of authentic pseudorandom numbers.

Aspect 38. The method of aspects 24-37, wherein the initial seed value further comprises one or more values associated with the first product selected from: a product date; a manufacturing plant ID code, manufacturing line information, or batch number information.

Aspect 39. The method of aspects 24-38, wherein the initial seed value comprises at least one of: (a) a value determined from analysing one or more printed areas at respective predefined locations on a surface of the first product; or (b) a value determined from analysing the first dot code of the first product.

Aspect 40. The method of aspect 25, wherein the seed value further comprises one or more values associated with the suspect product selected from: a manufacturing plant ID code, manufacturing line information, or batch number information.

Aspect 41. The method of aspects 24-40, wherein a first dot of the first dot code comprises a printable unit area within the first 2D code, and wherein a second dot of the second dot code comprises a printable unit area within the second 2D code.

Aspect 42. The method of aspects 24-41, wherein the first 2D code is a first QR code and a first dot of the first dot code comprises a module of the first QR code, wherein the second 2D code is a second QR code and a second dot of the second dot code comprises a module of the second QR code.

Aspect 43. The method of aspect 25, wherein the one or more printed areas comprises: (a) at least a portion of a 2D code; (b) at least a portion of a batch code; and/or (c) at least a portion of a dot code.

Aspect 44. The method of aspects 24-43, wherein a resolution of the first 2D code is defined in pixels having a pixel length and a pixel width, wherein the resolution of the first 2D code corresponds to an error correction value that defines a percentage of pixels than can be missing from the first 2D code while allowing the first 2D code to remain scannable, and wherein the first dot code is printed on the first 2D code covering an area of pixels equal to or less than the percentage of pixels that can be missing.

Aspect 45. The method of aspect 44, wherein the area of pixels for printing the first dot code comprises an area having a 12 pixel length and a 12 pixel width.

Aspect 46. The method of aspects 24-44, wherein the first dot code comprises a first data matrix code, and/or wherein the second dot code comprises a second data matrix code.

Aspect 47. A tangible, non-transitory computer-readable medium storing instructions for product authentication via two-dimensional (2D) codes using dot codes, that when executed by one or more processors cause the one or more to: generate, by a 2D code printing application (app) comprising computing instructions configured to be executed by one or more processors, an authenticating sequence of authentic pseudorandom numbers by inputting an initial seed value into a cryptographic algorithm to output an initial authenticating pseudorandom number in the authenticating sequence, wherein the initial seed value corresponds to a first product that is part of a product batch, wherein the first product has a first 2D code printed thereon, wherein a second product has a second 2D code printed thereon, the second product being part of the product batch, wherein each subsequent authenticating pseudorandom number in the authenticating sequence is generated directly or indirectly from the initial authenticating pseudorandom number whereby the initial authenticating pseudorandom number or a subsequent derivative thereof is input into the cryptographic algorithm to output a next authenticating pseudorandom number of the authenticating sequence, generate, by the 2D code printing app, a first dot code based on a first set of one or more pseudorandom numbers in the authenticating sequence, generate, by the 2D code printing app, a second dot code based on a second set of one or more pseudorandom numbers in the authenticating sequence, control, by the one or more processors, a printer to print the first dot code on the first 2D code of the first product, and control, by the one or more processors, the printer to print the second dot code on the second 2D code of the second product.

### ADDITIONAL CONSIDERATIONS

Although the disclosure herein sets forth a detailed description of numerous different aspects, it should be understood that the legal scope of the description is defined by the words of the claims set forth at the end of this patent and equivalents. The detailed description is to be construed as exemplary only and does not describe every possible aspect since describing every possible aspect would be impractical. Numerous alternative aspects may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location, while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., a server farm). In other aspects, the one or more processors or processor-implemented modules may be distributed across a number of geographic locations.

This detailed description is to be construed as exemplary only and does not describe every possible aspect, as describing every possible aspect would be impractical, if not impossible. A person of ordinary skill in the art may implement numerous alternate aspects, using either current technology or technology developed after the filing date of this application.

Those of ordinary skill in the art will recognize that a wide variety of modifications, alterations, and combinations can be made with respect to the above described aspects without departing from the scope of the invention, and that such modifications, alterations, and combinations are to be viewed as being within the ambit of the inventive concept.

The patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular aspects of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system configured for product authentication via two-dimensional (2D) codes using dot codes, the system comprising:
one or more processors; and
a 2D code printing application (app) comprising computing instructions configured to be executed by the one or more processors,
wherein the computing instructions of the 2D code printing app, when executed by the one or more processors, are configured to cause the one or more processors to:
generate an authenticating sequence of authentic pseudorandom numbers by inputting an initial seed value into a cryptographic algorithm to output an initial authenticating pseudorandom number in the authenticating sequence,
wherein the initial seed value corresponds to a first product that is part of a product batch, wherein the first product has a first 2D code printed thereon, wherein a second product has a second 2D code printed thereon, the second product being part of the product batch,
wherein each subsequent authenticating pseudorandom number in the authenticating sequence is generated directly or indirectly from the initial authenticating pseudorandom number whereby the initial authenticating pseudorandom number or a subsequent derivative thereof is input into the cryptographic algorithm to output a next authenticating pseudorandom number of the authenticating sequence,
generate a first dot code based on a first set of one or more pseudorandom numbers in the authenticating sequence,
generate a second dot code based on a second set of one or more pseudorandom numbers in the authenticating sequence,
control, by the one or more processors, a printer to print the first dot code on the first 2D code of the first product, and
control, by the one or more processors, the printer to print the second dot code on the second 2D code of the second product.

2. The system of claim 1 further comprising:
an authentication application (app) comprising instructions configured to be executed by the one or more processors,
wherein the instructions of the authentication app, when executed by the one or more processors, are configured to cause the one or more processors to:
determine a suspect pseudorandom number from a 2D code printed on a suspect product,
determine a seed value by analysing one or more printed areas at respective predefined locations as printed on the suspect product,
generate a test sequence of test pseudorandom numbers by inputting the seed value into the cryptographic algorithm to output an initial test pseudorandom number in the test sequence, wherein each subsequent test pseudorandom number in the test sequence is generated directly or indirectly from the initial test pseudorandom number whereby the initial test pseudorandom number or a subsequent derivative thereof is input into the cryptographic algorithm to output a next test pseudorandom alphanumeric number of the test sequence, and
generate an output comprising one of:
(1) an authenticating output indicating that the suspect product is authentic when the suspect pseudorandom number matches a test alphanumeric pseudorandom number derived from at least one test pseudorandom number of the test sequence; or
(2) a counterfeit output indicating that the suspect product is counterfeit when the suspect pseudorandom number fails to match a test alphanumeric pseudorandom number derived from at least one test pseudorandom number of the test sequence.

3. The system of claim 2,
wherein the authentication app comprises computing instructions of a mobile app configured to be executed by a device processor of a mobile device,
wherein the computing instructions, when executed by the device processor, is configured to cause the device processor to:
capture, by a camera of the mobile device, an image comprising the 2D code and/or the one or more printed areas at respective predefined locations, the 2D code and/or the one or more printed areas at respective predefined locations comprising suspect batch code information as printed on the suspect product, and
determine the seed value from the image comprising the suspect batch code information.

4. The system of claim 3, wherein the suspect batch code information is included in the 2D code printed on the suspect product.

5. The system of claim 1, wherein at least one of the first dot code and the second dot code comprises at least one of: (a) a matrix, arrangement, or pattern of dots; (b) a predefined matrix, arrangement, or pattern of dots; and/or (c) a matrix, arrangement, or pattern of dots having a predefined location or placement within a perimeter of the first 2D code or the second 2D code.

6. The system of claim 5, wherein the computing instructions of the 2D code printing app, when executed by the one or more processors, are further configured to cause the one or more processors to:
covert at least one pseudorandom number of the first set of one or more pseudorandom numbers into a binary number, the binary number having a plurality of binary digits,
wherein each dot of the dot code corresponds to a binary digit of the plurality of binary digits.

7. The system of claim 6, wherein each dot of the first dot code and the second dot code corresponds to a reverse value of a binary digit of the plurality of binary digits.

8. The system of claim 6, wherein one or more dots of the first dot code and the second dot code are defined at an arbitrarily position within the dot code.

9. The system of claim 5, wherein at least one of the first dot code and the second dot code comprises a border of non-data dots.

10. The system of claim 5, wherein the computing instructions of the 2D code printing app, when executed by the one or more processors, are further configured to cause the one or more processors to:
generate a series of block patterns, wherein each block pattern represents a number value, and wherein each block pattern defines a dot pattern comprising: (a) one or more dots; and/or (b) an absence of one or more dots,
assign a position within the dot code for each digit of a pseudorandom number of the first set of one or more pseudorandom numbers,
for each digit of a pseudorandom number, print each dot of the dot code by applying the dot pattern of a number value at the position of the digit assigned within the dot code.

11. The system of claim 5, wherein the first dot code is printed as a grouping of dots in a defined area of the first 2D code of the first product.

12. The system of claim 5, wherein the first dot code is printed as a distributed set of dots, wherein each dot of the distributed set of dots has a predefined location within the first 2D code of the first product.

13. The system of claim 3,
wherein generation of the output further comprises submitting one or both of the suspect batch code information and the suspect pseudorandom number to an authentication database comprising a list of known counterfeit pseudo-random codes,
wherein the counterfeit output is provided in response when the one or both of the suspect batch code and the suspect pseudorandom number match at least one known counterfeit pseudo-random code identified within the known counterfeit pseudo-random codes, and
wherein the authenticating output is provided in response when the one or both of the suspect batch code and the suspect pseudorandom number fail to match at least one known counterfeit batch code within the known counterfeit pseudo-random codes.

14. The system of claim 1, wherein the first product and the second product are packaged as part of a package or unit of products each having associated with an authentic pseudorandom number selected from the authenticating sequence of authentic pseudorandom numbers.

15. The system of claim 1, wherein the initial seed value further comprises one or more values associated with the first product selected from: a product date, a manufacturing plant ID code, manufacturing line information, or batch number information.

16. The system of claim 1, wherein the initial seed value comprises at least one of: (a) a value determined from analysing one or more printed areas at respective predefined locations on a surface of the first product; or (b) a value determined from analysing the first dot code of the first product.

17. The system of claim 2, wherein the seed value further comprises one or more values associated with the suspect product selected from: a manufacturing plant ID code, manufacturing line information, or batch number information.

18. The system of claim 1, wherein a first dot of the first dot code comprises a printable unit area within the first 2D code, and wherein a second dot of the second dot code comprises a printable unit area within the second 2D code.

19. A method for product authentication via two-dimensional (2D) codes using dot codes, the method comprising:
generating, by a 2D code printing application (app) comprising computing instructions configured to be executed by one or more processors, an authenticating sequence of authentic pseudorandom numbers by inputting an initial seed value into a cryptographic algorithm to output an initial authenticating pseudorandom number in the authenticating sequence,
wherein the initial seed value corresponds to a first product that is part of a product batch, wherein the first product has a first 2D code printed thereon, wherein a second product has a second 2D code printed thereon, the second product being part of the product batch,
wherein each subsequent authenticating pseudorandom number in the authenticating sequence is generated directly or indirectly from the initial authenticating pseudorandom number whereby the initial authenticating pseudorandom number or a subsequent derivative thereof is input into the cryptographic algorithm to output a next authenticating pseudorandom number of the authenticating sequence,
generating, by the 2D code printing app, a first dot code based on a first set of one or more pseudorandom numbers in the authenticating sequence,
generating, by the 2D code printing app, a second dot code based on a second set of one or more pseudorandom numbers in the authenticating sequence,
controlling, by the one or more processors, a printer to print the first dot code on the first 2D code of the first product, and
controlling, by the one or more processors, the printer to print the second dot code on the second 2D code of the second product.

20. A tangible, non-transitory computer-readable medium storing instructions for product authentication via two-dimensional (2D) codes using dot codes, that when executed by one or more processors cause the one or more to:
generate, by a 2D code printing application (app) comprising computing instructions configured to be executed by one or more processors, an authenticating sequence of authentic pseudorandom numbers by inputting an initial seed value into a cryptographic algorithm to output an initial authenticating pseudorandom number in the authenticating sequence,
wherein the initial seed value corresponds to a first product that is part of a product batch, wherein the first product has a first 2D code printed thereon, wherein a second product has a second 2D code printed thereon, the second product being part of the product batch,
wherein each subsequent authenticating pseudorandom number in the authenticating sequence is generated directly or indirectly from the initial authenticating pseudorandom number whereby the initial authenticating pseudorandom number or a subsequent derivative thereof is input into the cryptographic algorithm to output a next authenticating pseudorandom number of the authenticating sequence,
generate, by the 2D code printing app, a first dot code based on a first set of one or more pseudorandom numbers in the authenticating sequence,
generate, by the 2D code printing app, a second dot code based on a second set of one or more pseudorandom numbers in the authenticating sequence,
control, by the one or more processors, a printer to print the first dot code on the first 2D code of the first product, and
control, by the one or more processors, the printer to print the second dot code on the second 2D code of the second product.
